(19) United States
(12) Patent Application Publication
(10) Pub. No.: US 2018/0212447 A1
(43) Pub. Date: Jul. 26, 2018

(54) ELECTRONIC APPARATUS, ELECTRONIC APPARATUS SYSTEM, AND METHOD OF OPERATING ELECTRONIC APPARATUS

(71) Applicant: KYOCERA CORPORATION, Kyoto (JP)

(72) Inventor: Hiroki TABATA, Yokohama-shi, Kanagawa (JP)

(73) Assignee: KYOCERA CORPORATION, Kyoto (JP)

(21) Appl. No.: 15/576,230

(22) PCT Filed: Mar. 31, 2016
(86) PCT No.: PCT/JP2016/060694

§ 371 Date: Nov. 21, 2017

(30) Foreign Application Priority Data
May 27, 2015 (JP) 2015-107336

(51) Int. Cl. H02J 7/00; H02J 50/10; H02J 50/80; H04M 1/02

(52) U.S. Cl. CPC H02J 7/0044; H02J 50/10; H02J 7/007; H04M 1/0202; H02J 50/80

(57) ABSTRACT

An electronic apparatus includes a first battery to be charged by a detachable charging apparatus and a contactless charging apparatus. The electronic apparatus includes a charging processing unit, a judgment unit, and a determination unit. The charging processing unit performs first charging of charging the first battery using first power of a second battery supplied from the detachable charging apparatus attached to the electronic apparatus and second charging of charging the first battery using second power transmitted from the contactless charging apparatus in a contactless manner. The judgment unit judges whether the detachable charging apparatus is attached to the electronic apparatus. The determination unit determines, when the judgment unit judges that the detachable charging apparatus is attached to the electronic apparatus, that transmission of the second power from the contactless charging apparatus is not possible.

### TECHNICAL FIELD

The present invention relates to an electronic apparatus.

### BACKGROUND ART

As disclosed in Patent Document 1, various techniques concerning electronic apparatuses have been proposed.

### PRIOR ART DOCUMENT

### Patent Document

Patent Document 1: Japanese Unexamined Patent Application Publication No. 2008-131812

### SUMMARY

### Problem to be Solved by the Invention

A battery included in an electronic apparatus is sometimes charged by a detachable charging apparatus detachably attachable to the electronic apparatus. When the battery of the electronic apparatus is charged in a contactless manner by a contactless charging apparatus with the detachable charging apparatus being attached to the electronic apparatus, the detachable charging apparatus can generate heat.

The present invention has been conceived in view of the above-mentioned point, and aims to provide technology enabling suppression of heat generation of the charging apparatus attached to the electronic apparatus.

### Means to Solve the Problem

An electronic apparatus, an electronic apparatus system, and a method of operating an electronic apparatus are disclosed. In one embodiment, the electronic apparatus includes a first battery to be charged by a detachable charging apparatus and a contactless charging apparatus. The electronic apparatus includes a charging processing unit, a judgment unit, and a determination unit. The charging processing unit performs first charging of charging the first battery using first power of a second battery supplied from the detachable charging apparatus attached to the electronic apparatus and second charging of charging the first battery using second power transmitted from the contactless charging apparatus in a contactless manner. The judgment unit judges whether the detachable charging apparatus is attached to the electronic apparatus. The determination unit determines, when the judgment unit judges that the detachable charging apparatus is attached to the electronic apparatus, that transmission of the second power from the contactless charging apparatus is not possible.

In one embodiment, the electronic apparatus system includes: an electronic apparatus including a first battery to be charged by a contactless charging apparatus; and a detachable charging apparatus including a second battery, being detachably attachable to a surface of the electronic apparatus, and charging the first battery. The electronic apparatus includes a charging processing unit, a judgment unit, and a determination unit. The charging processing unit performs first charging of charging the first battery using first power of the second battery supplied from the detachable charging apparatus attached to the electronic apparatus and second charging of charging the first battery using second power transmitted from the contactless charging apparatus in a contactless manner. The judgment unit judges whether the detachable charging apparatus is attached to the electronic apparatus. The determination unit determines, when the judgment unit judges that the detachable charging apparatus is attached to the electronic apparatus, that transmission of the second power from the contactless charging apparatus is not possible.

In one embodiment, the electronic apparatus system includes an electronic apparatus including a first battery to be charged by a detachable charging apparatus; and a contactless charging apparatus charging the first battery. The detachable charging apparatus includes a second battery, and is detachably attachable to a surface of the electronic apparatus. The electronic apparatus includes the charging processing unit, the judgment unit, and the determination unit. The charging processing unit performs first charging of charging the first battery using first power of the second battery supplied from the detachable charging apparatus attached to the electronic apparatus and second charging of charging the first battery using second power transmitted from the contactless charging apparatus in a contactless manner. The judgment unit judges whether the detachable charging apparatus is attached to the electronic apparatus. The determination unit determines, when the judgment unit judges that the detachable charging apparatus is attached to the electronic apparatus, that transmission of the second power from the contactless charging apparatus is not possible.

In one embodiment, the electronic apparatus system includes: an electronic apparatus including a first battery; a detachable charging apparatus including a second battery, being detachably attachable to a surface of the electronic apparatus, and charging the first battery; and a contactless charging apparatus charging the second battery. The electronic apparatus includes a charging processing unit, a judgment unit, and a determination unit. The charging processing unit performs first charging of charging the first battery using first power of the second battery supplied from the detachable charging apparatus attached to the electronic apparatus and second charging of charging the first battery using second power transmitted from the contactless charging apparatus in a contactless manner. The judgment unit judges whether the detachable charging apparatus is attached to the electronic apparatus. The determination unit determines, when the judgment unit judges that the detachable charging apparatus is attached to the electronic apparatus, that transmission of the second power from the contactless charging apparatus is not possible.

In one embodiment, a method of operating an electronic apparatus is a method of operating an electronic apparatus including a first battery to be charged by a detachable charging apparatus and a contactless charging apparatus. The detachable charging apparatus includes a second battery, and is detachably attachable to a surface of the electronic apparatus. The method of operating the electronic apparatus includes a first step, a second step, and a third step. In the first step, first charging of charging the first battery using first power of the second battery supplied from the detachable charging apparatus attached to the electronic apparatus and second charging of charging the first battery using second power transmitted from the contactless charging apparatus in a contactless manner are performed. In the second step, it is judged whether the detachable charging apparatus is attached to the electronic apparatus. In the third step, it is determined, when it is judged that the detachable charging apparatus is attached to the electronic apparatus in the second step, that transmission of the second power from the contactless charging apparatus is not possible.

### Effects of the Invention

Heat generation of the charging apparatus attached to the electronic apparatus can be suppressed.

### BRIEF DESCRIPTION OF DRAWINGS

FIG. 1 is a block diagram showing an example of the configuration of an electronic apparatus system.

FIG. 2 is a front view illustrating an example of the appearance of an electronic apparatus.

FIG. 3 is a rear view illustrating an example of the appearance of the electronic apparatus.

FIG. 4 is a side view illustrating an example of the appearance of the electronic apparatus.

FIG. 5 is a side view illustrating an example of the appearance of the electronic apparatus.

FIG. 6 is a rear view illustrating an example of the appearance of a jacketed electronic apparatus.

FIG. 7 is a side view illustrating an example of the appearance of the jacketed electronic apparatus.

FIG. 8 is a front view illustrating an example of the appearance of a detachable charging apparatus.

FIG. 9 is a rear view illustrating an example of the appearance of the detachable charging apparatus.

FIG. 10 is a side view illustrating an example of the appearance of the detachable charging apparatus.

FIG. 11 is a perspective view illustrating an example of the appearance of a contactless charging apparatus.

FIG. 12 illustrates an example of the state of the electronic apparatus being mounted on the contactless charging apparatus.

FIG. 13 is a block diagram showing an example of the configuration of the electronic apparatus.

FIG. 14 is a block diagram showing an example of the configuration of the detachable charging apparatus.

FIG. 15 is a block diagram showing an example of the configuration of a power supply unit of the electronic apparatus.

FIG. 16 illustrates an example of a cross-sectional structure of the electronic apparatus and the contactless charging apparatus.

FIG. 17 is a flowchart showing an example of the operation of the electronic apparatus.

FIG. 18 illustrates a display example of the electronic apparatus.

FIG. 19 illustrates an example of the state of the jacketed electronic apparatus being mounted on the contactless charging apparatus.

FIG. 20 is a flowchart showing an example of the operation of the electronic apparatus.

FIG. 21 is a flowchart showing an example of the operation of the electronic apparatus.

FIG. 22 illustrates a display example of the electronic apparatus.

FIG. 23 illustrates a display example of the electronic apparatus.

FIG. 24 illustrates a display example of the electronic apparatus.

FIG. 25 illustrates a display example of the electronic apparatus.

FIG. 26 illustrates a display example of the electronic apparatus.

FIG. 27 illustrates an example of the state of the electronic apparatus being operated.

FIG. 28 illustrates an example of the state of the electronic apparatus being operated.

FIG. 29 is a flowchart showing an example of the operation of the electronic apparatus.

FIG. 30 is a flowchart showing an example of the operation of the electronic apparatus.

FIG. 31 is a flowchart showing an example of the operation of the electronic apparatus.

### DESCRIPTION OF EMBODIMENTS

<Overview of Electronic Apparatus System>

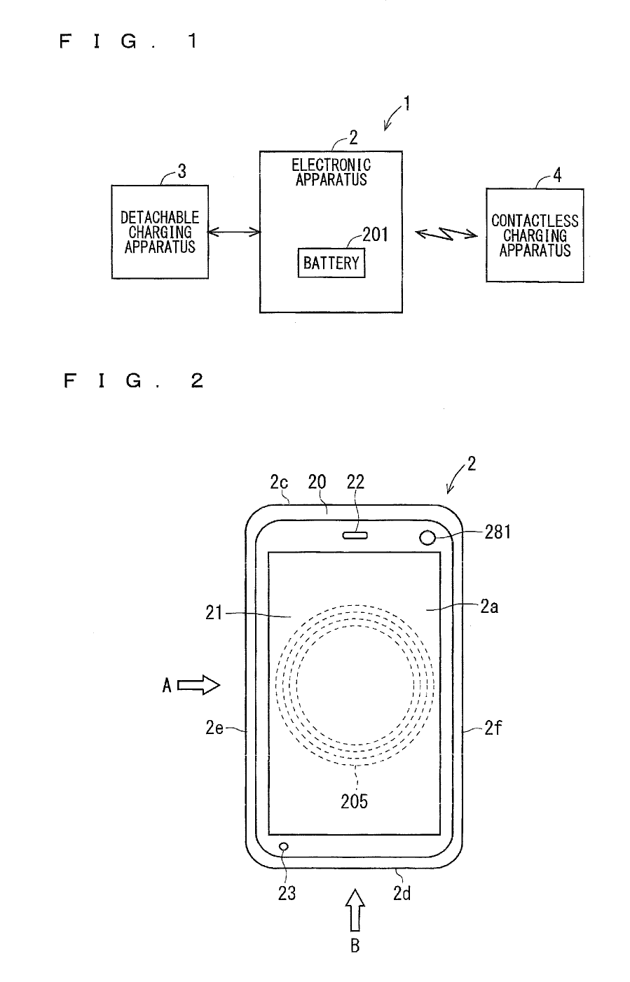

FIG. 1 is a block diagram showing an example of the configuration of an electronic apparatus system 1. As shown in FIG. 1, the electronic apparatus system 1 includes an electronic apparatus 2, a detachable charging apparatus 3, and a contactless charging apparatus 4.

The electronic apparatus 2 is, for example, a mobile phone, such as a smartphone. The electronic apparatus 2 can perform communication with another communication apparatus through a base station, a server, and the like. The electronic apparatus 2 includes a rechargeable battery 201.

The contactless charging apparatus 4 can perform contactless charging of the battery 201 of the electronic apparatus 2. Contactless charging is also referred to as “wireless charging” or “non-contact-point charging”.

The detachable charging apparatus 3 is detachably attachable to the surface of the electronic apparatus 2. With the detachable charging apparatus 3 being attached to the electronic apparatus 2, the detachable charging apparatus 3 can charge the battery 201 of the electronic apparatus 2. The detachable charging apparatus 3 includes a battery, and can supply power of the battery to the battery 201 of the electronic apparatus 2 to charge the battery 201.

The detachable charging apparatus 3 and the electronic apparatus 2 each have a plurality of connection terminals. When the detachable charging apparatus 3 is attached to the electronic apparatus 2, the plurality of connection terminals of the detachable charging apparatus 3 and the plurality of connection terminals of the electronic apparatus 2 come into contact with each other. This causes the detachable charging apparatus 3 and the electronic apparatus 2 to be electrically connected to each other. The detachable charging apparatus 3 can charge the battery 201 of the electronic apparatus 2 through the connection terminals of the detachable charging apparatus 3 and the connection terminals of the electronic apparatus 2 coming into contact with the connection terminals of the detachable charging apparatus 3. Charging of the battery 201 performed by the detachable charging apparatus 3 is also referred to as “contact charging” or “contact-point charging”.

<Appearance of Electronic Apparatus>

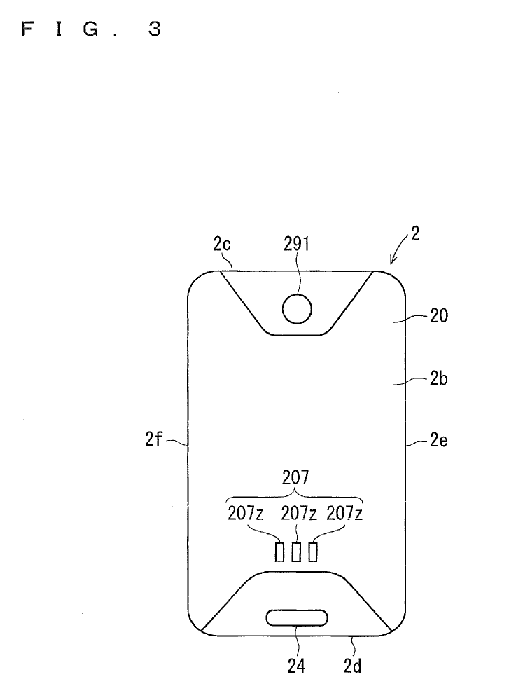

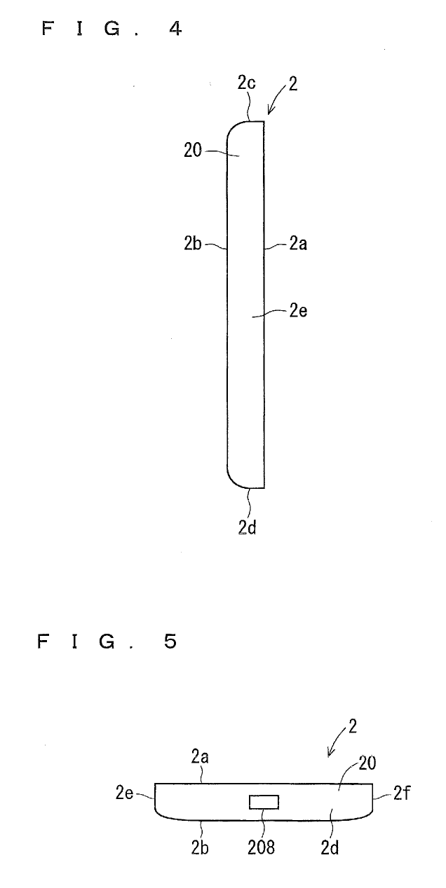

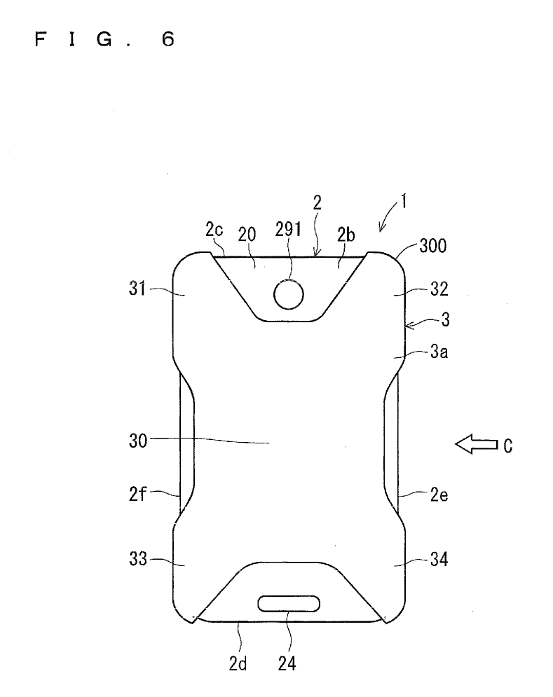

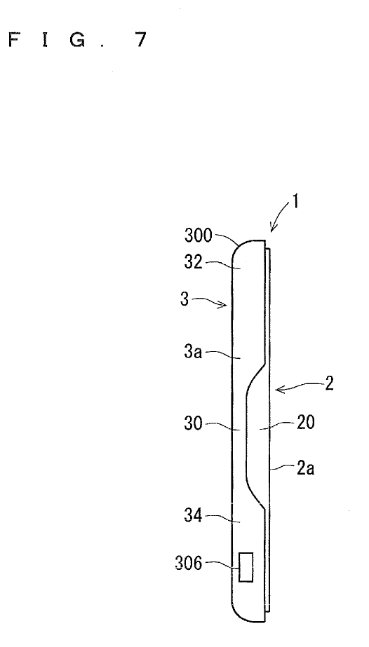

FIG. 2 is a front view illustrating an example of the appearance of the electronic apparatus 2. FIG. 3 is a rear view illustrating an example of the appearance of the electronic apparatus 2. FIG. 4 is a side view illustrating an example of the appearance of the electronic apparatus 2 as viewed in the direction of an arrow A of FIG. 2. FIG. 5 is a side view illustrating an example of the appearance of the electronic apparatus 2 as viewed in the direction of an arrow B of FIG. 2.

As illustrated in FIGS. 2 to 5, the electronic apparatus 2 includes an apparatus case 20 having an approximately rectangular plate-like shape in plan view. A front surface 2a of the electronic apparatus 2, namely, a front surface of the apparatus case 20 includes a display area 21 in which a variety of information, such as characters, symbols, and figures, is displayed. A touch panel 240, which will be described below, is stuck on a rear surface of the display area 21. This enables a user to input a variety of information into the electronic apparatus 2 by operating the display area 21 of the front surface 2a of the electronic apparatus 2 with, for example, a finger. The user can also input the variety of information into the electronic apparatus 2 by operating the display area 21 with an operator other than fingers that is, for example, a pen for electrostatic touch panels such as a stylus pen.

The apparatus case 20 has a microphone hole 23 and a receiver hole 22 respectively in a lower end portion and in an upper end portion of the front surface thereof. From the upper end portion of the front surface of the apparatus case 20, an imaging lens 281 of a front-side imaging unit 280, which will be described below, is visible. A lower side surface 2d of the apparatus case 20 has a universal serial bus (USB) connector 208 as illustrated in FIG. 5. A USB cable is connected to the USB connector 208. An external voltage (external power) is supplied from an AC adapter and the like to the USB connector 208 through the USB cable. The electronic apparatus 2 can charge the battery 201 using not only power supplied from the detachable charging apparatus 3 and the contactless charging apparatus 4 but also the external voltage supplied to the USB connector 208.

As illustrated in FIG. 3, a rear surface 2b of the electronic apparatus 2, namely, a rear surface of the apparatus case 20 has a speaker hole 24. From the rear surface of the apparatus case 20, an imaging lens 291 of a rear-side imaging unit 290, which will be described below, is visible. The rear surface of the apparatus case 20 also has a connection terminal group 207 composed of a plurality of connection terminals 207z for connecting the electronic apparatus 2 to the detachable charging apparatus 3. Each of the connection terminals 207z is made of a conductive material, such as metal. When the detachable charging apparatus 3 is attached to the electronic apparatus 2, the connection terminal group 207 comes into contact with a connection terminal group 307, which will be described below, of the detachable charging apparatus 3. This causes the electronic apparatus 2 and the detachable charging apparatus 3 to be electrically connected to each other.

A power transmitting coil for transmitting power to the electronic apparatus 2 is disposed inside the contactless charging apparatus 4. As illustrated in FIG. 2, a power receiving coil 205 for receiving power transmitted from the power transmitting coil of the contactless charging apparatus 4 is disposed inside the apparatus case 20. The battery 201 of the electronic apparatus 2 is charged based on power received by the power receiving coil 205.

<Appearance of Detachable Charging Apparatus>

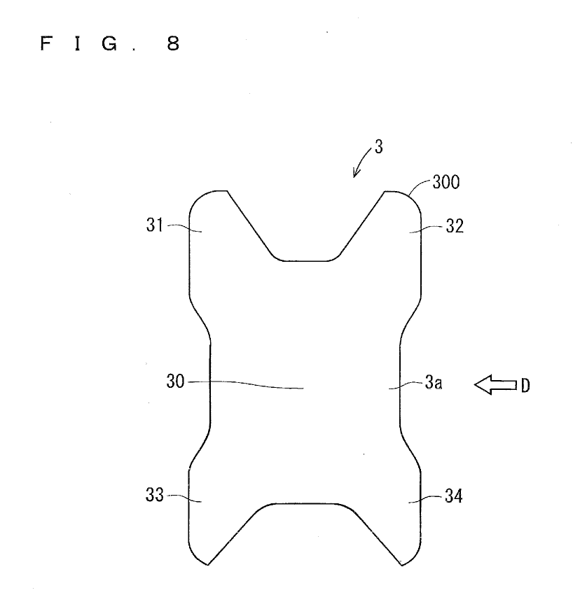

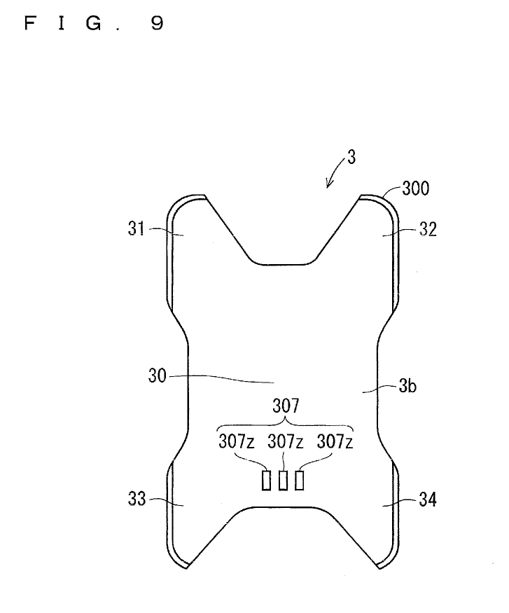

FIGS. 6 and 7 illustrate an example of the appearance of the electronic apparatus 2 to which the detachable charging apparatus 3 has been attached. The detachable charging apparatus 3 is attached, for example, to the rear surface 2b side of the electronic apparatus 2. FIG. 6 illustrates the electronic apparatus 2 to which the detachable charging apparatus 3 has been attached as viewed from the rear surface 2b side. FIG. 7 illustrates the electronic apparatus 2 to which the detachable charging apparatus 3 has been attached as viewed in the direction of an arrow C of FIG. 6. The detachable charging apparatus 3 is also referred to as a “jacket” or a “charging case”. The electronic apparatus 2 to which the detachable charging apparatus 3 has been attached is hereinafter also referred to as a “jacketed electronic apparatus 2”.

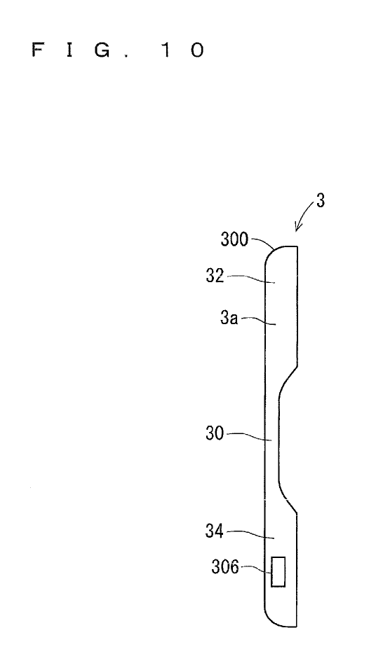

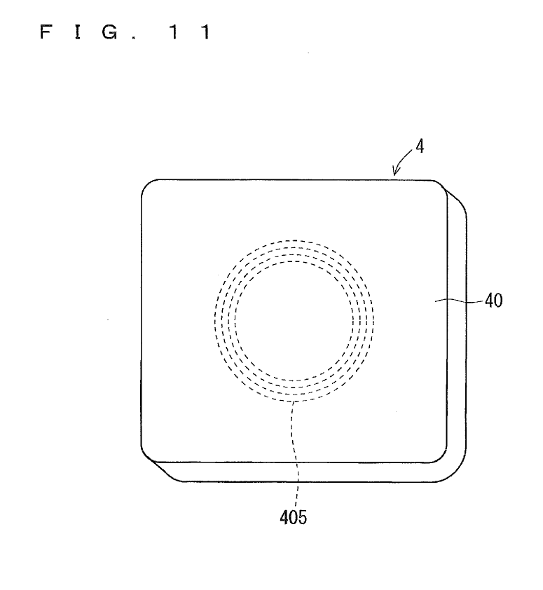

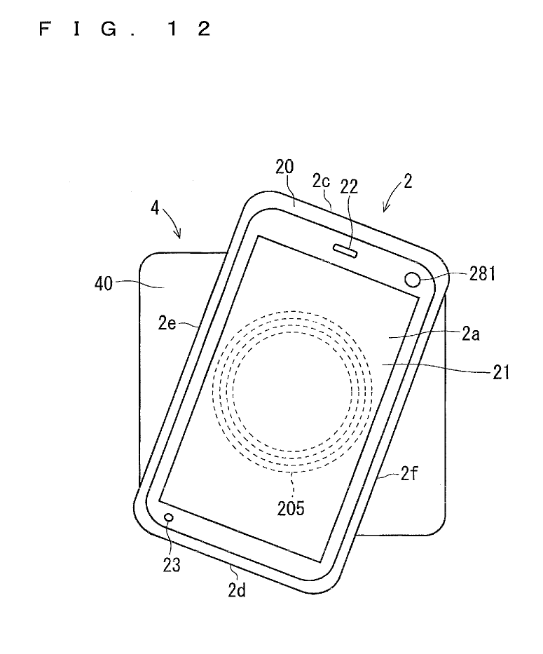

FIGS. 8 to 10 illustrate an example of the appearance of the detachable charging apparatus 3. FIG. 8 illustrates the detachable charging apparatus 3 as viewed from an outer surface 3a of a case 300 of the detachable charging apparatus 3. FIG. 9 illustrates the detachable charging apparatus 3 as viewed from an inner surface 3b of the case 300. FIG. 10 illustrates the detachable charging apparatus 3 as viewed in the direction of an arrow D of FIG. 8.

The detachable charging apparatus 3 includes the case 300 forming the exterior of the detachable charging apparatus 3. The case 300 is in the form of a shallow dish with its inner surface 3b slightly being recessed. The case 300 is so shaped that an upper side, a lower side, a left side, and a right side of a rectangle having four rounded corners are each recessed in the middle thereof in plan view.

The case 300 includes a center portion 30 and four holding portions 31 to 34 extending from four corners of the center portion 30. The four holding portions 31 to 34 hold respective corner portions at four corners of the electronic apparatus 2 (apparatus case 20), so that the detachable charging apparatus 3 is attached to the electronic apparatus 2. As illustrated in FIG. 6, the holding portions 31, 32, 33, and 34 respectively hold an upper left corner portion, an upper right corner portion, a lower left corner portion, and a lower right corner portion of the electronic apparatus 2 when the electronic apparatus 2 is viewed from the rear surface 2b side thereof. For example, the four holding portions 31 to 34 hold the respective corner portions at the four corners of the apparatus case 20 such that claw portions provided inside the four holding portions 31 to 34 fit into recessed portions provided in the respective corner portions.

As illustrated in FIG. 9, an inner surface of the center portion 300 has, in a lower end portion thereof, the connection terminal group 307 composed of a plurality of connection terminals 307z for connecting the detachable charging apparatus 3 to the electronic apparatus 2. Each of the connection terminals 307z is made of a conductive material, such as metal. When the detachable charging apparatus 3 is attached to the electronic apparatus 2, the plurality of connection terminals 307z of the detachable charging apparatus 3 and the plurality of connection terminals 207z of the electronic apparatus 2 come into contact with each other.

As illustrated in FIGS. 7 and 10, a curved portion of the outer surface 3a of the case 300 has a USB connector 306. Specifically, an outer surface of the holding portion 34 of the detachable charging apparatus 3 has the USB connector 306. A USB cable is connected to the USB connector 306. In the jacketed electronic apparatus 2, the USB cable can be connected to the USB connector 306 from a side surface. An external voltage is supplied from an AC adapter and the like to the USB connector 306 through the USB cable. The detachable charging apparatus 3 can charge the battery thereof using the external voltage supplied to the USB connector 306.

<Appearance of Contactless Charging Apparatus>

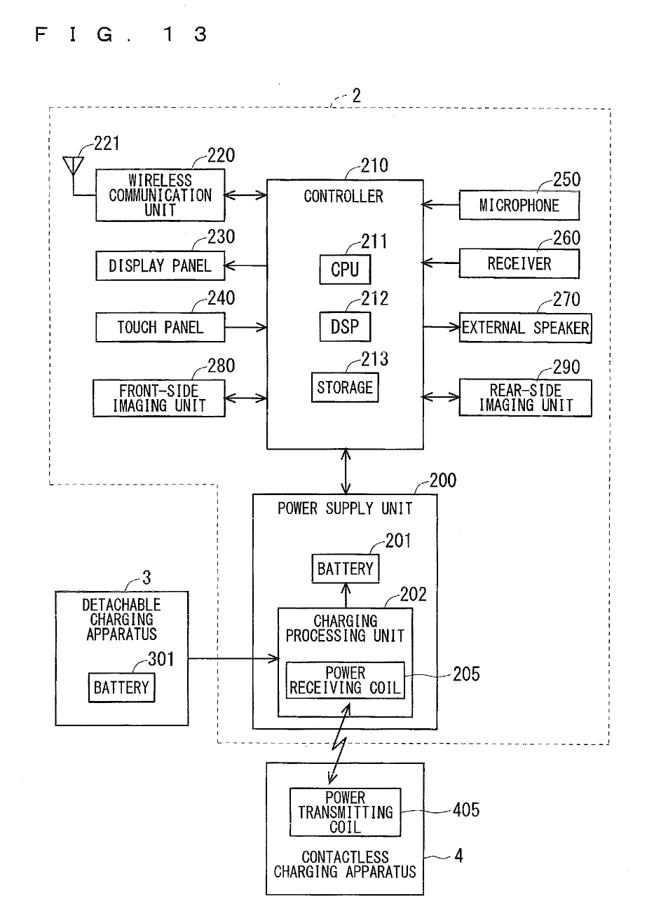

FIG. 11 is a perspective view illustrating the appearance of the contactless charging apparatus 4. As illustrated in FIG. 11, the contactless charging apparatus 4 includes a case 40. The case 40 is approximately a cuboid, for example. A power transmitting coil 405 for transmitting power to the electronic apparatus 2 is disposed inside the case 40.

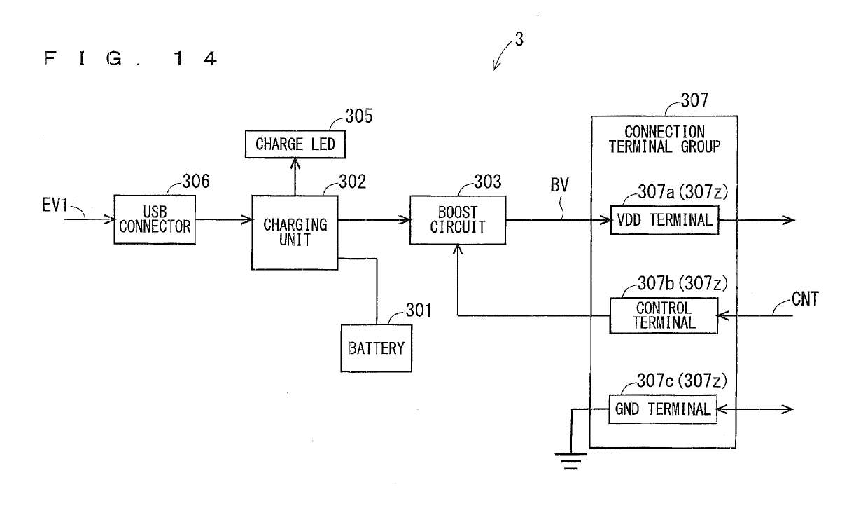

As illustrated in FIG. 12, with the electronic apparatus 2 being placed on the case 40 of the contactless charging apparatus 4, the battery 201 of the electronic apparatus 2 is charged by the contactless charging apparatus 4. The contactless charging apparatus 4 is also referred to as a “charging base”. Contactless charging of the battery 201 by the contactless charging apparatus 4 is performed in conformity with, for example, the standard referred to as Qi. Qi is the international standard developed by the Wireless Power Consortium (WPC). Contactless charging of the battery 201 by the contactless charging apparatus 4 may conform to other standards, such as the standard defined by the Power Matters Alliance (PMA).

The contactless charging apparatus 4 may be capable of mounting thereon a plurality of electronic apparatuses 2. The contactless charging apparatus 4 capable of mounting thereon the plurality of electronic apparatuses 2 can simultaneously charge the plurality of electronic apparatuses 2. The contactless charging apparatus 4 can charge not only the battery of the mobile phone, such as a smartphone, but also the batteries of the other types of electronic apparatuses.

<Electrical Configuration of Electronic Apparatus>

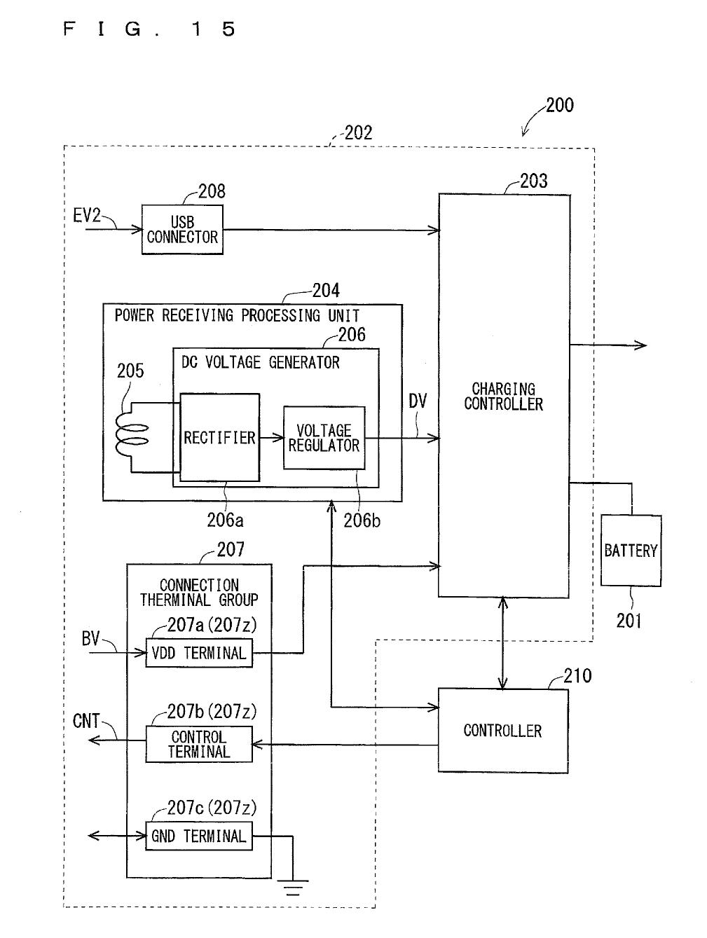

FIG. 13 is a block diagram mainly showing an example of the electrical configuration of the electronic apparatus 2. As shown in FIG. 13, the electronic apparatus 2 includes a power supply unit 200, a controller 210, a wireless communication unit 220, a display panel 230, and the touch panel 240. The electronic apparatus 2 also includes a microphone 250, a receiver 260, an external speaker 270, the front-side imaging unit 280, and the rear-side imaging unit 290. These components of the electronic apparatus 2 are housed in the apparatus case 20.

The controller 210 is a control circuit including processors, such as a central processing unit (CPU) 211 and a digital signal processor (DSP) 212, a storage 213, and the like. The controller 210 can manage the overall operation of the electronic apparatus 2 by controlling the other components of the electronic apparatus 2.

The storage 213 includes a non-transitory recording medium readable by the controller 210 (the CPU 211 and the DSP 212), such as a read only memory (ROM) and a random access memory (RAM). The storage 213 stores various programs for controlling the operation of each component of the electronic apparatus 2, such as the wireless communication unit 220 and the display panel 230. The CPU 211 and the DSP 212 execute the various programs stored in the storage 213 to achieve various functions of the controller 210. The storage 213 may include a non-transitory computer readable recording medium other than the ROM and the RAM. The storage 213 may include, for example, a compact hard disk drive, a solid state drive (SSD), and the like.

The wireless communication unit 220 includes an antenna 221. The wireless communication unit 220 can receive, using the antenna 221, a signal from a mobile phone other than the electronic apparatus 2 or a signal from a communication apparatus, such as a web server, connected to the Internet, via a base station and the like. The wireless communication unit 220 can perform amplification and down-conversion on the received signal, and output the processed received signal to the controller 210. The controller 210 can perform demodulation and the like on the received signal as input to acquire a sound signal indicating a voice and music, and the like included in the received signal. The wireless communication unit 220 can also perform up-conversion and amplification on a transmission signal generated by the controller 210 and including a sound signal and the like, and wirelessly transmit the processed transmission signal from the antenna 221. The transmission signal from the antenna 221 is received, via the base station and the like, by the mobile phone other than the electronic apparatus 2 or the communication apparatus connected to the Internet.

The display panel 230 is, for example, a liquid crystal display panel or an organic EL panel. The display panel 230 can display a variety of information, such as characters, symbols, and figures, through control performed by the controller 210. The display panel 230 is located to face the display area 21 in the apparatus case 20. The information displayed by the display panel 230 appears in the display area 21. The display panel 230 and the display area 21 constitute a display displaying and presenting the variety of information to the user. Display of the display is controlled by the controller 210.

The touch panel 240 can detect an operation performed on the display area 21 with an operator, such as a finger. The touch panel 240 is, for example, a projected capacitive touch panel, and is stuck on the rear surface of the display area 21. When the user performs an operation on the display area 21 with the operator, such as a finger, an electrical signal corresponding to the operation is input from the touch panel 240 into the controller 210. The controller 210 can specify details of the operation performed on the display area 21 based on the electrical signal from the touch panel 240, and perform processing in accordance with the specified details.

The microphone 250 can convert a sound input from the outside of the electronic apparatus 2 into an electrical sound signal, and output the electrical sound signal to the controller 210. The sound from the outside of the electronic apparatus 2 is taken through the microphone hole 23 into the electronic apparatus 2, and input into the microphone 250.

The external speaker 270 is, for example, a dynamic speaker. The external speaker 270 can convert the electrical sound signal from the controller 210 into a sound, and output the sound. The sound output from the external speaker 270 is output through the speaker hole 24 to the outside. The sound output through the speaker hole 24 can be heard even at a location away from the electronic apparatus 2.

The receiver 260 can output a received sound. The receiver 260 includes, for example, a dynamic speaker. The receiver 260 can convert the electrical sound signal from the controller 210 into a sound, and output the sound. The sound output from the receiver 260 is output through the receiver hole 22 to the outside. The volume of the sound output through the receiver hole 22 is lower than the volume of the sound output through the speaker hole 24.

The front-side imaging unit 280 includes the imaging lens 281, an image sensor, and the like. The front-side imaging unit 280 can capture a still image and a moving image based on control performed by the controller 210. The rear-side imaging unit 290 includes the imaging lens 291, an image sensor, and the like. The rear-side imaging unit 290 can capture a still image and a moving image based on control performed by the controller 210.

The power supply unit 200 can output a power supply for the electronic apparatus 2. The power supply output from the power supply unit 200 is supplied to various circuits of the electronic apparatus 2, such as the controller 210 and the wireless communication unit 220. The power supply unit 200 includes the battery 201 and a charging processing unit 202 charging the battery 201. The power supply unit 200 can output power of the battery 201 as the power supply. The power supply unit 200 can also output power supplied from the outside of the electronic apparatus 2 as the power supply for the electronic apparatus 2. The power supplied from the outside of the electronic apparatus 2 includes power supplied from the detachable charging apparatus 3, power supplied from the contactless charging apparatus 4, and external power supplied to the USB connector 208.

The charging processing unit 202 can charge the battery 201 based on power of a battery 301 supplied from the detachable charging apparatus 3. The charging processing unit 202 can charge the battery 201 based on power from the power transmitting coil 405 of the contactless charging apparatus 4 received by the power receiving coil 205. The charging processing unit 202 can charge the battery 201 based on the external power supplied to the USB connector 208.

<Electrical Configuration of Detachable Charging Apparatus>

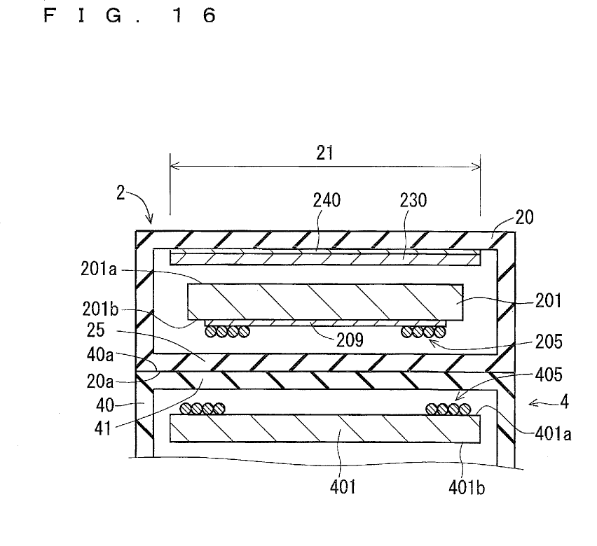

FIG. 14 is a block diagram showing an example of the electrical configuration of the detachable charging apparatus 3. As shown in FIG. 14, the detachable charging apparatus 3 includes the battery 301, a charging unit 302, a boost circuit 303, a charge LED 305, the USB connector 306, and the connection terminal group 307. These components are housed in the case 300.

The charging unit 302 is a circuit that can charge the battery 301 based on a first external voltage EV1 supplied to the USB connector 306. The charge light emitting diode (LED) 305 is a kind of a light emitting unit, and is controlled by the charging unit 302. The charge LED 305 can be turned on during charging of the battery 301. The charge LED 305 is provided to the detachable charging apparatus 3 so that the state of the charge LED 305 is visible from the outside of the detachable charging apparatus 3.

The boost circuit 303 is a kind of a DC/DC converter, and can boost an input voltage to 5 V, and output a boosted voltage BV obtained through boosting. The boosted voltage BV (5 V) is higher than an output voltage of the battery 301. The output voltage of the battery 301 when the battery 301 is fully charged is approximately 4.2 V. The boost circuit 303 can also suspend the output.

The plurality of connection terminals 307z constituting the connection terminal group 307 include a VDD terminal 307a, a control terminal 307b, and a GND terminal 307c. The VDD terminal 307a outputs the boosted voltage BV output from the boost circuit 303 to the outside of the detachable charging apparatus 3. A control signal CNT output from the electronic apparatus 2 is input into the control terminal 307b. The control signal CNT is a signal for controlling output of the boost circuit 303. The GND terminal 307d is connected to a ground potential in the detachable charging apparatus 3.

The boost circuit 303 includes, as an operation mode, a boost mode in which the output voltage of the battery 301 is boosted and output and a suspension mode in which the operation is suspended not to perform output. When the first external voltage EV1 is supplied to the USB connector 306, the boost circuit 303 operates in the suspension mode through control performed by the charging unit 302 regardless of a signal level of the control signal CNT. When the control signal CNT at a low level is input, the boost circuit 303 also operates in the suspension mode. When the boost circuit 303 operates in the suspension mode, the boosted voltage BV is not output from the VDD terminal 307a.

The boost circuit 303 operates in the boost mode when the first external voltage EV1 is not supplied to the USB connector 306, and the control signal CNT at a high level is input. When the boost circuit 303 operates in the boost mode, the boosted voltage BV is output from the VDD terminal 307a. The control signal CNT is also referred to as an “enable signal”.

The charging unit 302 can charge the battery 301 based on the first external voltage EV1. The charging unit 302 charges the battery 301 based on the first external voltage EV1 when the first external voltage EV1 is supplied to the USB connector 306, and the battery 301 is not fully charged. The charging unit 302 sets the operation mode of the boost circuit 303 to the suspension mode when the first external voltage EV1 is supplied to the USB connector 306. The boosted voltage BV is thus not output from the VDD terminal 307a during charging of the battery 301. The charging unit 302 turns on the charge LED 305 during charging of the battery 301, and turns off the charge LED 305 upon completion of charging of the battery 301.

On the other hand, when the first external voltage EV1 is not supplied to the USB connector 306, the charging unit 302 supplies the output voltage of the battery 301 to the boost circuit 303 without charging the battery 301. In this case, when the control signal CNT is at a high level, and the boost circuit 303 operates in the boost mode, the boosted voltage BV obtained by boosting the output voltage of the battery 301 to 5 V is output from the VDD terminal 307a.

<Configuration of Power Supply Unit of Electronic Apparatus>

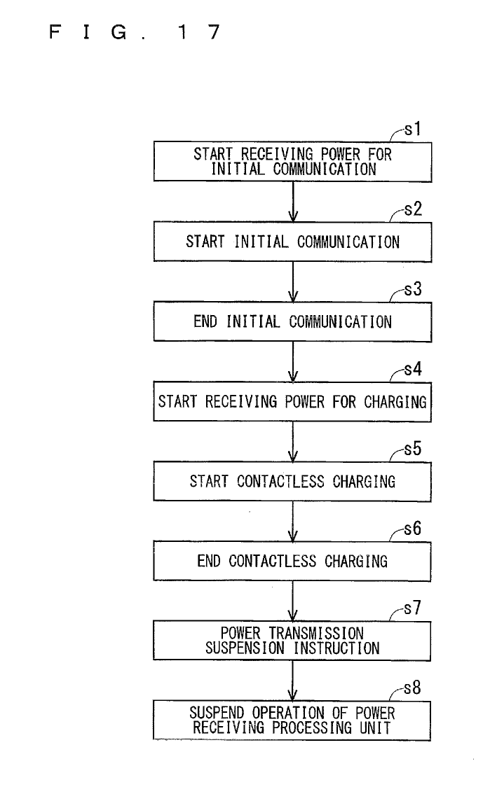

FIG. 15 mainly shows the configuration of the power supply unit 200 of the electronic apparatus 2. As shown in FIG. 15, the power supply unit 200 includes the battery 201 and the charging processing unit 202 that can charge the battery 201. The charging processing unit 202 includes a charging controller 203 that can charge the battery 201, a power receiving processing unit 204 receiving power from the contactless charging apparatus 4, the connection terminal group 207, and the USB connector 208. The charging controller 203 and the power receiving processing unit 204 are controlled by the controller 210.

The plurality of connection terminals 207z constituting the connection terminal group 207 include a VDD terminal 207a, a control terminal 207b, and a GND terminal 207c. The VDD terminal 207a comes into contact with the VDD terminal 307a of the detachable charging apparatus 3. The boosted voltage BV output from the detachable charging apparatus 3 is input into the VDD terminal 207a. The control terminal 207b comes into contact with the control terminal 307b of the detachable charging apparatus 3. The control signal CNT output from the controller 210 is input into the control terminal 207b. The GND terminal 207c is connected to a ground potential in the electronic apparatus 2.

The power receiving processing unit 204 is a kind of an electrical circuit, and includes the power receiving coil 205 and a DC voltage generator 206. The DC voltage generator 206 is a circuit that can generate a DC voltage DV based on power received by the power receiving coil 205, and output the DC voltage DV. The DC voltage generator 206 includes a rectifier 206a and a voltage regulator 206b. The rectifier 206a can rectify power generated by the power receiving coil 205 to generate a DC voltage. The voltage regulator 206b can step down the DC voltage generated by the rectifier 206a to generate the DC voltage DV. The power receiving processing unit 204 can perform communication with the contactless charging apparatus 4 using the power receiving coil 205 based on a communication scheme in conformity with Qi.

The charging controller 203 is a circuit that can control charging of the battery 201. The charging controller 203 can charge the battery 201 based on the boosted voltage BV input into the VDD terminal 207a. The charging controller 203 charges the battery 201 based on the boosted voltage BV, so that contact charging (contact-point charging) of the battery 201 is performed by the detachable charging apparatus 3. The charging controller 203 can charge the battery 201 based on the DC voltage DV output from the DC voltage generator 206. The charging controller 203 charges the battery 201 based on the DC voltage DV, so that contactless charging of the battery 201 is performed by the contactless charging apparatus 4. The power receiving processing unit 204 can charge the battery 201 based on a second external voltage EV2 supplied to the USB connector 208.

The charging controller 203 can supply the boosted voltage BV input into the VDD terminal 207a to various circuits, such as the controller 210, as a power supply voltage of the electronic apparatus 2. The charging controller 203 can supply the DC voltage DV output from the DC voltage generator 206 to various circuits, such as the controller 210, as the power supply voltage of the electronic apparatus 2. The charging controller 203 can supply the second external voltage EV2 supplied to the USB connector 208 to various circuits, such as the controller 210, as the power supply voltage of the electronic apparatus 2. When none of the second external voltage EV2, the DC voltage DV, and the boosted voltage BV is input, the charging controller 203 outputs the output voltage of the battery 201 as the power supply voltage.

The charging controller 203 can output, to the controller 210, state notification information for notifying the controller 210 of the state of the charging processing unit 202. The state notification information includes information indicating whether the battery 201 is fully charged, information indicating whether the battery 201 is being charged, information indicating whether the second external voltage EV2 is supplied to the USB connector 208, information indicating whether the boosted voltage BV is input into the VDD terminal 207a, and the like. This allows the controller 210 to know whether the battery 201 is fully charged, whether the battery 201 is being charged, whether the second external voltage EV2 is supplied to the USB connector 208, and whether the boosted voltage BV is input into the VDD terminal 207a.

The controller 210 basically sets the signal level of the control signal CNT to the high level. The controller 210 sets the signal level of the control signal CNT to the low level when the operation of the boost circuit 303 is suspended. For example, when the battery 201 is fully charged, the controller 210 sets the signal level of the control signal CNT to the low level to suspend the operation of the boost circuit 303. The controller 210 sets the signal level of the control signal CNT to the low level to suspend the operation of the boost circuit 303 also when the temperature of the battery 201 becomes an abnormal temperature during charging of the battery 201. The electronic apparatus 2 includes a temperature sensor detecting the temperature of the battery 201. The controller 210 can judge whether the temperature of the battery 201 is the abnormal temperature based on the result of detection of the temperature sensor.

The controller 210 can suspend the operation of the power receiving processing unit 204. For example, the controller 210 suspends the operation of the power receiving processing unit 204 when the battery 201 is fully charged. The controller 210 suspends the operation of the power receiving processing unit 204 also when the temperature of the battery 201 becomes the abnormal temperature during charging of the battery 201. In a case where the operation of the power receiving processing unit 204 is suspended, the DC voltage DV is not output from the power receiving processing unit 204 even when the power receiving coil 205 receives power from the contactless charging apparatus 4.

<Transmission of Power from Power Transmitting Coil to Power Receiving Coil>

Transmission of power from the power transmitting coil 405 to the power receiving coil 205 will be described in details next. FIG. 16 schematically shows an example of a cross-sectional structure of the contactless charging apparatus 4 and the electronic apparatus 2 mounted on the contactless charging apparatus 4.

The power receiving coil 205 and the power transmitting coil 405 each include a wound conductor. The power receiving coil 205 is positioned so that a winding axis of the conductor is approximately orthogonal to a rear surface 20a of the apparatus case 20 of the electronic apparatus 2 (a surface of the apparatus case 20 being in contact with the contactless charging apparatus 4). The power transmitting coil 405 is positioned so that a winding axis of the conductors is approximately orthogonal to a mounting surface 40a of the case 40 of the contactless charging apparatus 4 on which the electronic apparatus 2 is mounted.

In the apparatus case 20 of the electronic apparatus 2, the battery 201 is located to face the display panel 230. The battery 201 has a first main surface 201a facing the display panel 230 and a second main surface 201b opposite the first main surface 201a. The power receiving coil 205 is stuck on a magnetic sheet 209, and the magnetic sheet 209 is stuck on the second main surface 201b of the battery 201. This means that the power receiving coil 205 is attached to the second main surface 201b of the battery 201 through the magnetic sheet 209. The power receiving coil 205 is located to face a rear surface portion 25 of the apparatus case 20. There is a gap between the power receiving coil 205 and the rear surface portion 25 of the apparatus case 20. The power receiving coil 205 may not be stuck on the battery 201.

In the case 40 of the contactless charging apparatus 4, a magnetic sheet 401 is provided to face a mounting portion 41 of the case 40 on which the electronic apparatus 2 is mounted. The magnetic sheet 401 has a first main surface 401a facing the mounting portion 41 of the case 40 and a second main surface 401b opposite the first main surface 401a. The power transmitting coil 405 is stuck on the first main surface 401a of the magnetic sheet 401. The power transmitting coil 405 is located to face the mounting portion 41 of the case 40. There is a gap between the power transmitting coil 405 and the mounting portion 41 of the case 40.

When the electronic apparatus 2 is mounted on the mounting surface 40a of the case 40 of the contactless charging apparatus 4 so that the rear surface 20a of the apparatus case 20 of the electronic apparatus 2 comes into contact with the mounting surface 40a, the power receiving coil 205 and the power transmitting coil 405 face each other. When the power transmitting coil 405 is energized in this state, and a magnetic flux is generated from the power transmitting coil 405, the magnetic flux is linked to the power receiving coil 205. Induced electromotive force is thus generated in the power receiving coil 205. This means that the power receiving coil 205 receives power transmitted from the power transmitting coil 405. The charging processing unit 202 of the electronic apparatus 2 charges the battery 201 based on the induced electromotive force generated in the power receiving coil 205. Such contactless charging is referred to as “electromagnetic induction charging”.

The magnetic sheet 209 provided to the electronic apparatus 2 and the magnetic sheet 401 provided to the contactless charging apparatus 4 suppress external leakage of the magnetic flux passing through the power receiving coil 205 and the power transmitting coil 405. This improves power transmission efficiency (also referred to as “power supply efficiency”) when power is transmitted from the contactless charging apparatus 4 to the electronic apparatus 2.

<Operation of Electronic Apparatus at Contactless Charging>

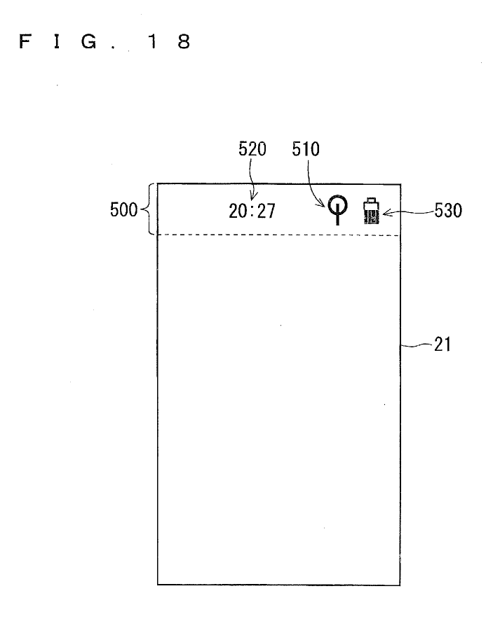

FIG. 17 is a flowchart showing an example of the operation of the electronic apparatus 2 when the battery 201 of the electronic apparatus 2 is charged in a contactless manner by the contactless charging apparatus 4.

The electronic apparatus 2 performs initial communication with the contactless charging apparatus 4 before charging of the battery 201 using power transmitted from the contactless charging apparatus 4. The contactless charging apparatus 4 intermittently transmits, from the power transmitting coil 405, power for initial communication used when the electronic apparatus 2 performs the initial communication. After the initial communication, the contactless charging apparatus 4 continuously transmits, from the power transmitting coil 405, power for charging used by the electronic apparatus 2 to charge the battery 201. The contactless charging apparatus 4 intermittently transmits the power for initial communication while the contactless charging apparatus 4 performs the initial communication with the electronic apparatus 2.

When the electronic apparatus 2 is mounted on the contactless charging apparatus 4, the power receiving processing unit 204 starts receiving, using the power receiving coil 205, the power for initial communication intermittently transmitted by the contactless charging apparatus 4 in step s1 as shown in FIG. 17. In step s2, the power receiving processing unit 204 starts the initial communication with the contactless charging apparatus 4 using the received power for initial communication as a power supply. In this initial communication, the power receiving processing unit 204 transmits a variety of information to the contactless charging apparatus 4 by controlling a current flowing through the power receiving coil 205. In the initial communication, the power receiving processing unit 204 transmits, to the contactless charging apparatus 4, information necessary for the contactless charging apparatus 4 to perform authentication of the electronic apparatus 2, such as identification information of the electronic apparatus 2, received power information indicating power received by the power receiving coil 205, and the like.

After step s2, when the initial communication ends in step s3, that is, when the power receiving processing unit 204 ends transmission of the variety of information, the power receiving processing unit 204 starts receiving, using the power receiving coil 205, the power for charging transmitted by the contactless charging apparatus 4 in step s4. When the initial communication with the power receiving processing unit 204 ends, the contactless charging apparatus 4 performs authentication of the electronic apparatus 2 based on the information received from the power receiving processing unit 204 in the initial communication. When the contactless charging apparatus 4 successfully authenticates the electronic apparatus 2, the contactless charging apparatus 4 determines a value of transmitted power necessary for contactless charging of the battery 201 of the electronic apparatus 2 based on the received power information and the like received from the power receiving processing unit 204 in the initial communication. The contactless charging apparatus 4 continuously transmits the power for charging having the determined value from the power transmitting coil 405 instead of transmitting the power for initial communication.

When the power receiving processing unit 204 starts receiving the power for charging, the charging processing unit 202 starts charging of the battery 201 using the received power for charging in step s5. In the charging processing unit 202, the DC voltage generator 206 generates the DC voltage DV based on the power for charging received by the power receiving coil 205, and outputs the DC voltage DV to the charging controller 203. The charging controller 203 charges the battery 201 based on the DC voltage DV.

During charging of the battery 201, the controller 210 causes the display panel 230 to display first notification information 510 notifying the user that the battery 201 is being charged in a contactless manner by the contactless charging apparatus 4. The display panel 230 displays the first notification information 510 in the display area 21 of the front surface 2a of the electronic apparatus 2.

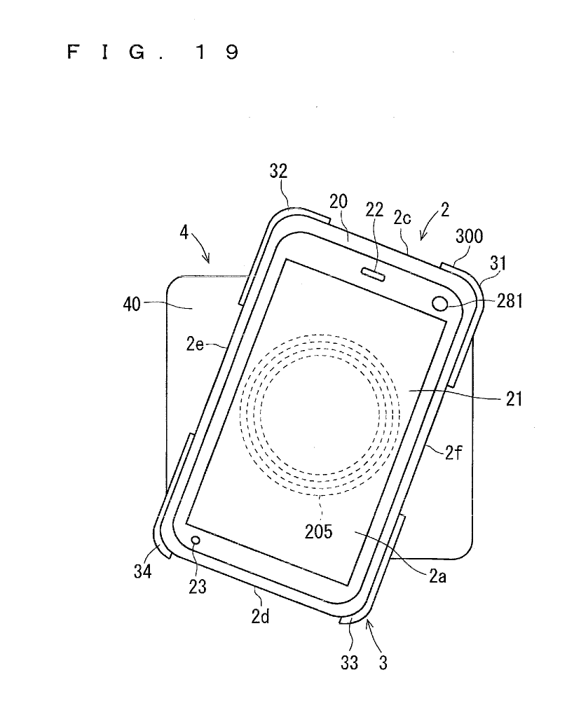

FIG. 18 illustrates a display example of the first notification information 510 in the display area 21. As illustrated in FIG. 18, a notification screen 500 for providing various notifications to the user is displayed in the display area 21. The notification screen 500 is displayed in the display area 21 whenever display is provided in the display area 21. The notification screen 500 is thus included in each of a home screen and a lock screen. The notification screen 500 is displayed, for example, in an upper end portion of the display area 21. The first notification information 510 is displayed in the notification screen 500. The first notification information 510 is an icon, for example. The first notification information 510 is hereinafter also referred to as a “first notification icon 510”. The notification screen 500 includes, in addition to the first notification icon 510, time information 520 indicating the current time, battery level information 530 indicating the current capacity (battery level) of the battery 201, and the like, for example. The time information 520 is, for example, a character string, and the battery level information 530 is, for example, an icon.

After the start of charging of the battery 201, when the charging controller 203 judges that the battery 201 is fully charged in step s6, the charging controller 203 ends charging of the battery 201. When charging of the battery 201 ends, the power receiving processing unit 204 transmits, using the power receiving coil 205, a power transmission suspension signal instructing the contactless charging apparatus 4 to suspend transmission of the power for charging in step s7. When the controller 210 determines that charging of the battery 201 has ended based on the state notification information from the charging controller 203, the controller 210 controls the power receiving processing unit 204 so that the power receiving processing unit 204 transmits the power transmission suspension signal.

When the power transmission suspension signal is transmitted from the electronic apparatus 2, the controller 210 suspends the operation of the power receiving processing unit 204 in step s8. When the contactless charging apparatus 4 receives the power transmission suspension signal, the contactless charging apparatus 4 suspends transmission of the power for charging. The contactless charging apparatus 4 then starts intermittent transmission of the power for initial communication. In the electronic apparatus 2 including the battery 201 that is fully charged, the operation of the power receiving processing unit 204 starts again through control performed by the controller 210 when power of the battery 201 is consumed, and the battery 201 is no longer fully charged.

When the power receiving processing unit 204 receives the power for charging, the power receiving processing unit 204 transmits the received power information and the like on a regular basis to the contactless charging apparatus 4 using the power for charging. This enables the contactless charging apparatus 4 transmitting the power for charging to determine whether the electronic apparatus 2 is mounted on the mounting surface 40a of the contactless charging apparatus 4, in other words, whether the electronic apparatus 2 is located close to the contactless charging apparatus 4. When the contactless charging apparatus 4 transmitting the power for charging can no longer receive the information from the power receiving processing unit 204, the contactless charging apparatus 4 determines that the electronic apparatus 2 is not mounted on the mounting surface 40a, and suspends transmission of the power for charging. The contactless charging apparatus 4 then starts intermittent transmission of the power for initial communication.

As the operation of the power receiving processing unit 204 is suspended when the battery 201 is fully charged, the power receiving processing unit 204 does not perform the initial communication when the battery 201 is fully charged even if the power for initial communication is received by the power receiving coil 205. The contactless charging apparatus 4 thus does not transmit the power for charging when the battery 201 is fully charged even if the electronic apparatus 2 is mounted on the contactless charging apparatus 4.

<Determination of Whether Power Transmission from Contactless Charging Apparatus is Possible>

In FIGS. 12 and 16 described above, the electronic apparatus 2 is mounted on the contactless charging apparatus 4 with the detachable charging apparatus 3 being not attached to the electronic apparatus 2.

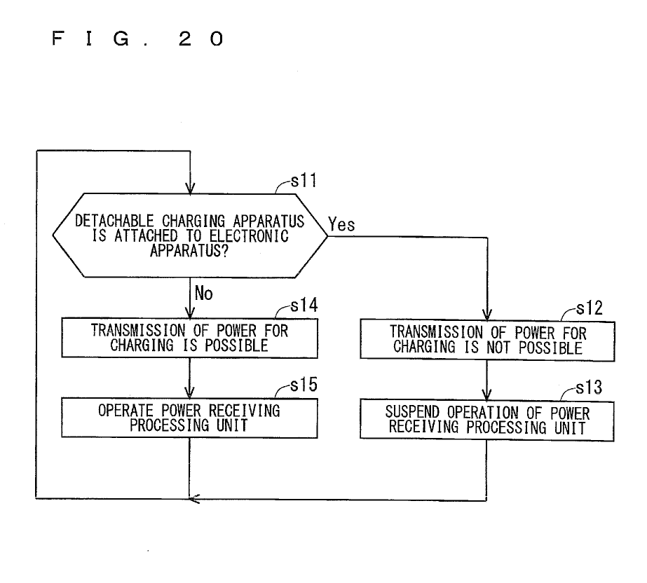

On the other hand, as illustrated in FIG. 19, the electronic apparatus 2 can be mounted on the contactless charging apparatus 4 with the detachable charging apparatus 3 being attached to the electronic apparatus 2. When the battery 201 of the electronic apparatus 2 is charged in a contactless manner by the contactless charging apparatus 4 with the electronic apparatus 2 to which the detachable charging apparatus 3 has been attached being mounted on the contactless charging apparatus 4, the detachable charging apparatus 3 having been attached to the electronic apparatus 2 can generate heat.

The detachable charging apparatus 3 is attached to the rear surface 2b side of the electronic apparatus 2. Thus, as illustrated in FIG. 19, when the jacketed electronic apparatus 2 is mounted on the contactless charging apparatus 4 with the rear surface 2b side of the electronic apparatus 2 facing downward, the detachable charging apparatus 3 is located between the power receiving coil 205 of the electronic apparatus 2 and the power transmitting coil 405 of the contactless charging apparatus 4. When the contactless charging apparatus 4 transmits power from the power transmitting coil 405 in this state, metal contained in the detachable charging apparatus 3 can generate heat. For example, metal contained in the battery 501 and metal (a ground pattern and the like) contained in a substrate on which the boost circuit 303 and the like are mounted can generate heat. In a case where the case 300 contains metal, the case 300 can generate heat.

The controller 210 of the electronic apparatus 2 thus determines whether transmission of the power for charging from the contactless charging apparatus 4 is possible based on whether the detachable charging apparatus 3 is attached to the electronic apparatus 2. Specifically, when the detachable charging apparatus 3 is attached, the controller 210 determines that transmission of the power for charging from the contactless charging apparatus 4 is not possible. On the other hand, when the detachable charging apparatus 3 is not attached, the electronic apparatus 2 determines that transmission of the power for charging from the contactless charging apparatus 4 is possible. This can suppress transmission of the power for charging from the contactless charging apparatus 4 to the electronic apparatus 2 with the detachable charging apparatus 3 being attached to the electronic apparatus 2. As a result, heat generation of the detachable charging apparatus 3 attached to the electronic apparatus 2 can be suppressed.

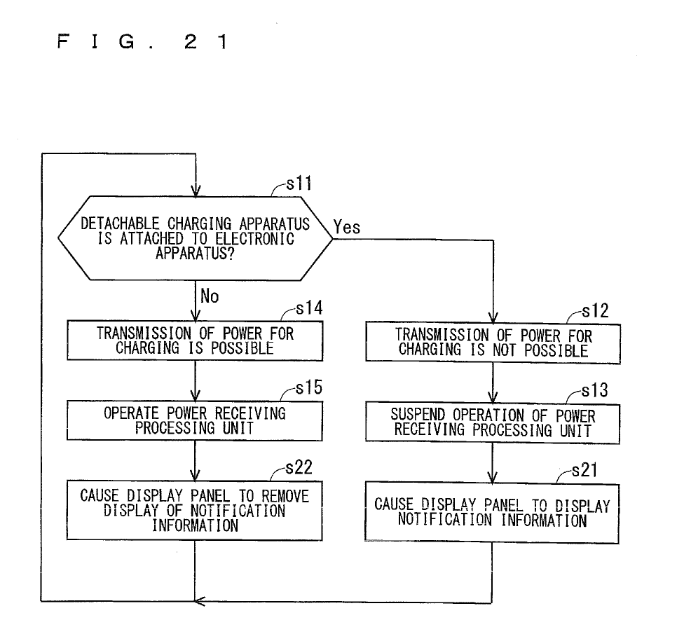

FIG. 20 is a flowchart showing an example of the operation of the controller 210 when the controller 210 determines whether transmission of the power for charging is possible. As shown in FIG. 20, the controller 210 judges whether the detachable charging apparatus 3 is attached to the electronic apparatus 2 in step s11. In step s11, the controller 210 determines whether the boosted voltage BV is input into the VDD terminal 207a based on the state notification information from the charging controller 203. When the controller 210 determines that the boosted voltage BV is input into the VDD terminal 207a, the controller 210 judges that the detachable charging apparatus 3 is attached to the electronic apparatus 2. On the other hand, when the controller 210 determines that the boosted voltage BV is not input into the VDD terminal 207a, the controller 210 judges that the detachable charging apparatus 3 is not attached to the electronic apparatus 2.

When the controller 210 judges that the detachable charging apparatus 3 is attached to the electronic apparatus 2 in step s11, the controller 210 determines that transmission of the power for charging from the contactless charging apparatus 4 is not possible in step s12. The controller 210 then suspends the operation of the power receiving processing unit 204 in step s13. When the operation of the power receiving processing unit 204 is suspended, the power receiving processing unit 204 cannot perform the initial communication with the contactless charging apparatus 4. The contactless charging apparatus 4 thus does not transmit the power for charging when the operation of the power receiving processing unit 204 is suspended. Thus, even if the electronic apparatus 2 to which the detachable charging apparatus 3 has been attached is mounted on the contactless charging apparatus 4, the power for charging is not transmitted from the contactless charging apparatus 4, and the battery 201 of the electronic apparatus 2 is not charged in a contactless manner. The electronic apparatus 2 suspends the operation of the power receiving processing unit 204 so that the power for charging is not transmitted from the contactless charging apparatus 4.

On the other hand, when the controller 210 judges that the detachable charging apparatus 3 is not attached to the electronic apparatus 2 in step s11, the controller 210 determines that transmission of the power for charging from the contactless charging apparatus 4 is possible in step s14. The controller 210 then operates the power receiving processing unit 204 in step s15. When the detachable charging apparatus 3 is not attached to the electronic apparatus 2, the power receiving processing unit 204 operates, so that the power receiving processing unit 204 can perform the initial communication with the contactless charging apparatus 4. Thus, if the electronic apparatus 2 to which the detachable charging apparatus 3 has not been attached is mounted on the contactless charging apparatus 4, the power for charging is transmitted from the contactless charging apparatus 4, and the battery 201 of the electronic apparatus 2 is charged in a contactless manner.

After step s13, the controller 210 performs step s11 again, and thereafter operates in a similar manner After step s15, the controller 210 performs step s11 again, and thereafter operates in a similar manner. The controller 210 performs step s11, for example, on a regular basis.

As described above, when the electronic apparatus 2 to which the detachable charging apparatus 3 has not been attached is moved close to the contactless charging apparatus 4, the contactless charging apparatus 4 transmits the power for charging to the electronic apparatus 2. The electronic apparatus 2 to which the detachable charging apparatus 3 has not been attached thus can charge the battery 201 based on the power for charging from the contactless charging apparatus 4.

On the other hand, when the electronic apparatus 2 to which the detachable charging apparatus 3 has been attached is moved close to the contactless charging apparatus 4, the contactless charging apparatus 4 does not transmit the power for charging to the electronic apparatus 2. The electronic apparatus 2 to which the detachable charging apparatus 3 has been attached thus cannot charge the battery 201 based on the power for charging from the contactless charging apparatus 4.

<Charging Control in Electronic Apparatus Based on Plurality of Types of Power>

<When External Voltage is Supplied to Electronic Apparatus>

When the second external voltage EV2 is supplied to the USB connector 208 of the electronic apparatus 2, the charging controller 203 charges the battery 201 based on the second external voltage EV2, and outputs the second external voltage EV2 as the power supply voltage, regardless of whether the power receiving coil 205 receives the power for charging and whether the boosted voltage BV is input into the VDD terminal 207a.

Specifically, when the battery 201 is not fully charged, the charging controller 203 charges the battery 201 based on the second external voltage EV2, and outputs the second external voltage EV2 as the power supply voltage. On the other hand, when the battery 201 is fully charged, the charging controller 203 outputs the second external voltage EV2 as the power supply voltage without charging the battery 201.

When the second external voltage EV2 is supplied to the USB connector 208, the controller 210 sets the control signal CNT at the low level, and suspends the operation of the power receiving processing unit 204.

<When External Voltage is not Supplied to Electronic Apparatus>

When the second external voltage EV2 is not supplied to the USB connector 208, the operation of the charging processing unit 202 varies depending on whether the detachable charging apparatus 3 is attached to the electronic apparatus 2.

<When Detachable Charging Apparatus is not Attached to Electronic Apparatus>

When the detachable charging apparatus 3 is not attached to the electronic apparatus 2, the power receiving processing unit 204 operates, so that the DC voltage DV is output from the power receiving processing unit 204. When the second external voltage EV2 is not supplied to the USB connector 208 of the electronic apparatus 2, and the detachable charging apparatus 3 is not attached to the electronic apparatus 2, the charging controller 203 charges the battery 201 based on the DC voltage DV from the power receiving processing unit 204, and outputs the DC voltage DV as the power supply voltage. When the battery 201 is fully charged, the charging controller 203 outputs the DC voltage DV as the power supply voltage without charging the battery 201.

<When Detachable Charging Apparatus is Attached to Electronic Apparatus>

When the detachable charging apparatus 3 is attached to the electronic apparatus 2, the operation of the power receiving processing unit 204 is suspended. The DC voltage DV is thus not output from the power receiving processing unit 204. When the second external voltage EV2 is not supplied to the USB connector 208 of the electronic apparatus 2, and the detachable charging apparatus 3 is attached to the electronic apparatus 2, the charging controller 203 charges the battery 201 based on the boosted voltage BV input into the VDD terminal 207a, and outputs the boosted voltage BV as the power supply voltage.

When the battery 201 is fully charged, the charging controller 203 outputs the boosted voltage DV as the power supply voltage without charging the battery 201.

When the first external voltage EV1 is supplied to the detachable charging apparatus 3 as described above, the output of the boost circuit 303 is suspended. In this case, the charging controller 203 outputs the output voltage of the battery 201 as the power supply voltage without charging the battery 201.

As described above, when the second external voltage EV2 is supplied to the electronic apparatus 2, the charging processing unit 202 performs charging of the battery 201 and the like based on the second external voltage EV2 regardless of whether power is supplied from the detachable charging apparatus 3 and the contactless charging apparatus 4.

When the second external voltage EV2 is not supplied to the electronic apparatus 2, and the detachable charging apparatus 3 is not attached to the electronic apparatus 2, the charging processing unit 202 performs charging of the battery 201 and the like based on the power for charging from the contactless charging apparatus 4.

When the second external voltage EV2 is not supplied to the electronic apparatus 2, and the detachable charging apparatus 3 is attached to the electronic apparatus 2, the charging processing unit 202 performs charging of the battery 201 and the like based on power from the detachable charging apparatus 3.

As described above, when it is judged that the detachable charging apparatus 3 is attached to the electronic apparatus 2, the electronic apparatus 2 determines that transmission of the power for charging from the contactless charging apparatus 4 is not possible. Transmission of the power for charging from the contactless charging apparatus 4 to the electronic apparatus 2 can thus be suppressed when the detachable charging apparatus 3 is attached to the electronic apparatus 2. Heat generation of the detachable charging apparatus 3 can thus be suppressed.

When it is determined that transmission of the power for charging from the contactless charging apparatus 4 is not possible, the operation of the power receiving processing unit 204 is suspended, and thus power consumption of the electronic apparatus 2 can be reduced.

<Various Modifications>

Various modifications will be described below.

<First Modification>

When transmission of the power for charging from the contactless charging apparatus 4 is not possible, the electronic apparatus 2 may notify the user that contactless charging is not performed. In this case, the electronic apparatus 2 notifies the user that contactless charging is not performed, for example, using the display including the display panel 230 and the display area 21. That is to say, the display functions as a notification unit notifying the user that contactless charging is not performed.

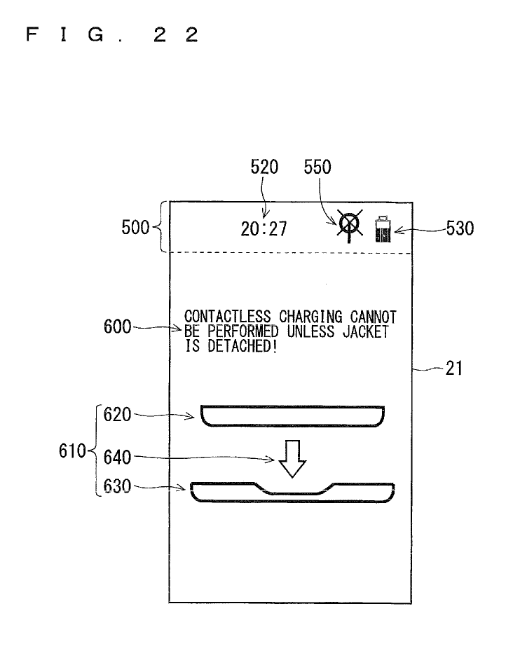

FIG. 21 is a flowchart showing an example of the operation of the controller 210 according to a first modification. The flowchart shown in FIG. 21 corresponds to the flowchart shown in FIG. 20 to which steps s21 and s22 have been added.

As shown in FIG. 21, when the controller 210 suspends the operation of the power receiving processing unit 204 in step s13, the controller 210 controls the display panel 230 so that the display panel 230 displays second notification information notifying the user that contactless charging is not performed in step s21. The controller 210 then performs step s11. The display panel 230 displays the second notification information in the display area 21 of the front surface 2a of the electronic apparatus 2.

When the controller 210 operates the power receiving processing unit 204 in step s15, the controller 210 controls the display panel 230 so that the display panel 230 removes display of the second notification information in step s22. The controller 210 then performs step s11. When the second notification information is not displayed by the display panel 230 after performance of step s15, for example, when the detachable charging apparatus 3 is attached to the electronic apparatus 2 for the first time, step s11 is performed without performing step s21.

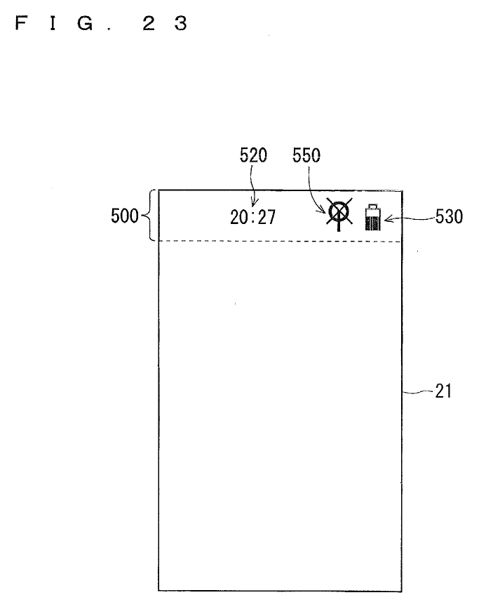

FIG. 22 illustrates a display example of the second notification information in the display area 21. As illustrated in FIG. 22, the notification screen 500 displayed in the display area 21 includes, as the second notification information, a second notification icon 550 notifying the user that contactless charging is not performed. The second notification icon 550 is an icon corresponding to the first notification icon 510 shown in FIG. 18 on which a cross has been superimposed, for example. By seeing the second notification icon 550, the user of the jacketed electronic apparatus 2 can know that contactless charging of the battery 201 is not performed even when the jacketed electronic apparatus 2 is mounted on the contactless charging apparatus 4.

Along with the second notification icon 550, third notification information 600 notifying the user that contactless charging is not performed unless the detachable charging apparatus (jacket) 3 is detached from the electronic apparatus 2 is displayed in the display area 21. The third notification information 600 includes, for example, a character string (symbol string) “CONTACTLESS CHARGING CANNOT BE PERFORMED UNLESS JACKET IS DETACHED!”. By seeing the third notification information 600, the user can know that contactless charging of the battery 201 is not performed unless the electronic apparatus 2 is mounted on the contactless charging apparatus 4 with the detachable charging apparatus 3 being detached from the electronic apparatus 2. The user can also know that contactless charging of the battery 201 of the electronic apparatus 2 is not performed under the present circumstances by seeing the third notification information 600. It can thus be said that the third notification information 600 is also the second notification information notifying the user that contactless charging is not performed.

In the display area 21, fourth notification information 610 notifying the user of detachment of the detachable charging apparatus 3 from the electronic apparatus 2 is displayed. The fourth notification information 610 includes, for example, figures. In the example of FIG. 22, the fourth notification information 610 includes a FIG. 620 schematically showing the appearance of the electronic apparatus 2 as viewed from a side surface of the electronic apparatus 2, a FIG. 630 schematically showing the appearance of the detachable charging apparatus 3 as viewed from a side surface of the detachable charging apparatus 3, and an arrow 640. The FIGS. 620 and 630 are vertically arranged so that the FIG. 620 is located over the FIG. 630. The arrow 640 is located between the FIGS. 620 and 630. The arrow 640 is directed from the FIG. 620 to the FIG. 630. Display of the fourth notification information 610 in addition to the third notification information 600 facilitates user's understanding of the need to detach the detachable charging apparatus 3 from the electronic apparatus 2 to perform contactless charging.

The third notification information 600 and the fourth notification information 610 are displayed in an area of the display area 21 other than the area in which the notification screen 500 is displayed to each have a larger size than the second notification icon 550, the time information 520, and the battery level information 530. When the home screen is displayed in the display area 21 in performing step s21, the third notification information 600 and the fourth notification information 610 are shown in the home screen. When the lock screen is displayed in the display area 21 in performing step s21, the third notification information 600 and the fourth notification information 610 are shown in the lock screen.

Display of the third notification information 600 and the fourth notification information 610 may be removed when the user performs a predetermined operation on the display area 21. Display of the third notification information 600 and the fourth notification information 610 may be removed after the third notification information 600 and the fourth notification information 610 are displayed for a period of time. As the second notification icon 550 is still displayed even when display of the third notification information 600 and the fourth notification information 610 is removed, the user can know that contactless charging is not performed. Removal of display of the third notification information 600 and the fourth notification information 610 can suppress obtrusiveness, to the user, of display of the third notification information 600 and the fourth notification information 610, which each have a large display size, for a long period of time.

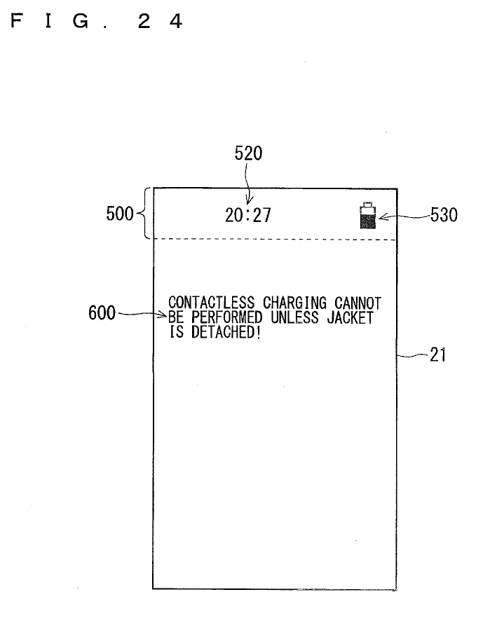

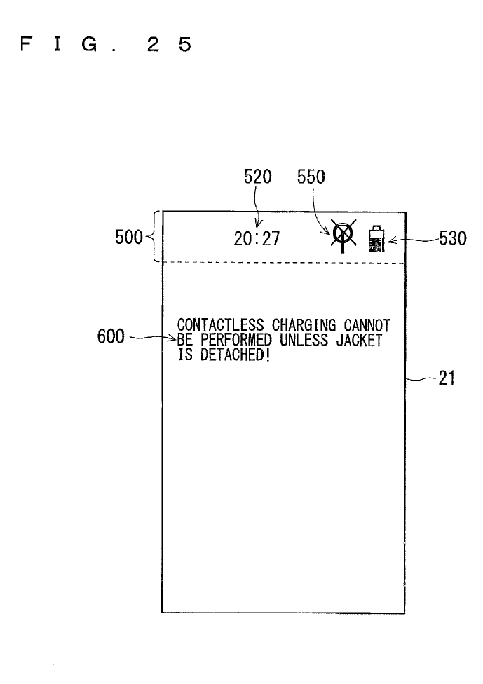

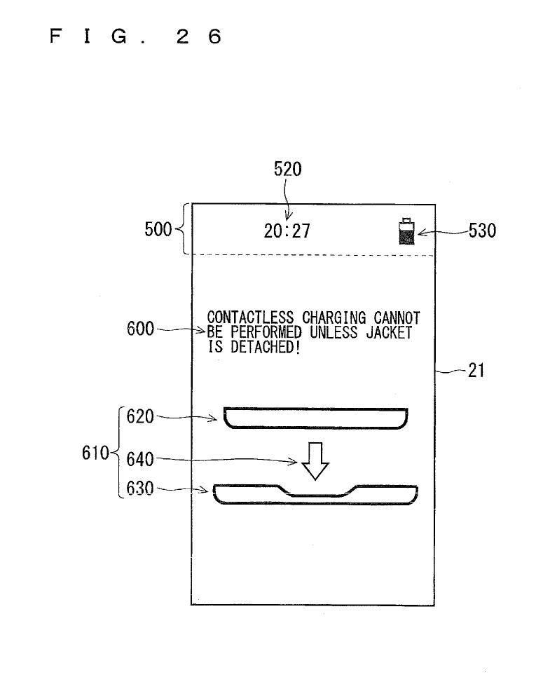

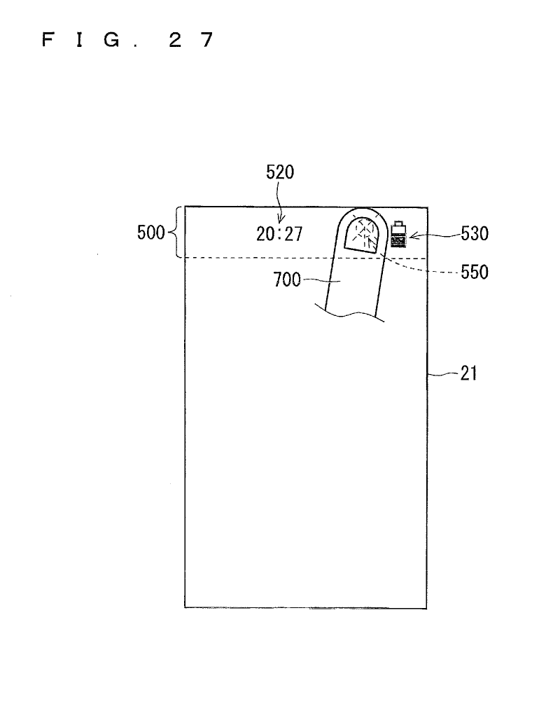

Although the second notification icon 550, the third notification information 600, and the fourth notification information 610 are displayed in the example of FIG. 22, at least one of the second notification icon 550 and the third notification information 600 may be displayed. For example, as illustrated in FIG. 23, only the second notification icon 550 may be displayed from among the second notification icon 550, the third notification information 600, and the fourth notification information 610. Alternatively, as illustrated in FIG. 24, only the third notification information 600 may be displayed from among the second notification icon 550, the third notification information 600, and the fourth notification information 610. Alternatively, as illustrated in FIG. 25, only the second notification icon 550 and the third notification information 600 may be displayed from among the second notification icon 550, the third notification information 600, and the fourth notification information 610. Alternatively, as illustrated in FIG. 26, only the third notification information 600 and the fourth notification information 610 may be displayed from among the second notification icon 550, the third notification information 600, and the fourth notification information 610. As the second notification icon 550 and the third notification information 600 are each the second notification information notifying the user that contactless charging is not performed, the user can know that contactless charging is not performed by displaying at least one of the second notification icon 550 and the third notification information 600.

Although the second notification icon 550, the third notification information 600, and the fourth notification information 610 are displayed at the same time in the example of FIG. 22, after display of the third notification information 600 and the fourth notification information 610 without displaying the second notification icon 550, display of the third notification information 600 and the fourth notification information 610 may be removed, and the second notification icon 550 may be displayed. This means that display in the display area 21 may change from the display of FIG. 26 to the display of FIG. 23. In this case, after the third notification information 600 and the fourth notification information 610 are displayed for a period of time without displaying the second notification icon 550, for example, display of the third notification information 600 and the fourth notification information 610 is removed, and the second notification icon 550 is displayed. This can suppress obtrusiveness, to the user, of display of the third notification information 600 and the fourth notification information 610, which each have a large display size, for a long period of time. Furthermore, as the second notification icon 550 is displayed after display of the third notification information 600 and the fourth notification information 610 is removed, the user can know that contactless charging is not performed.

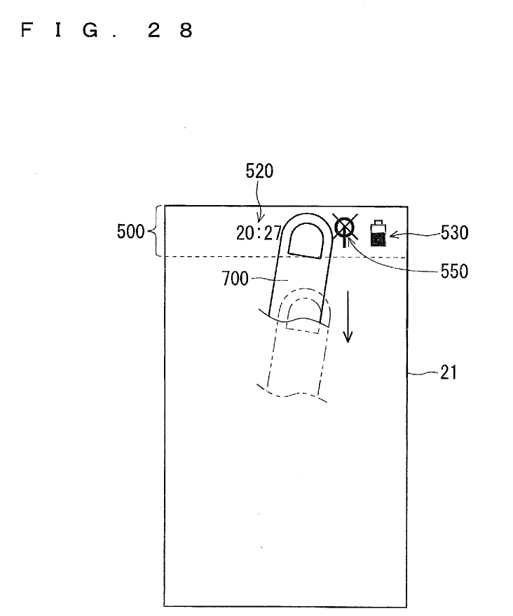

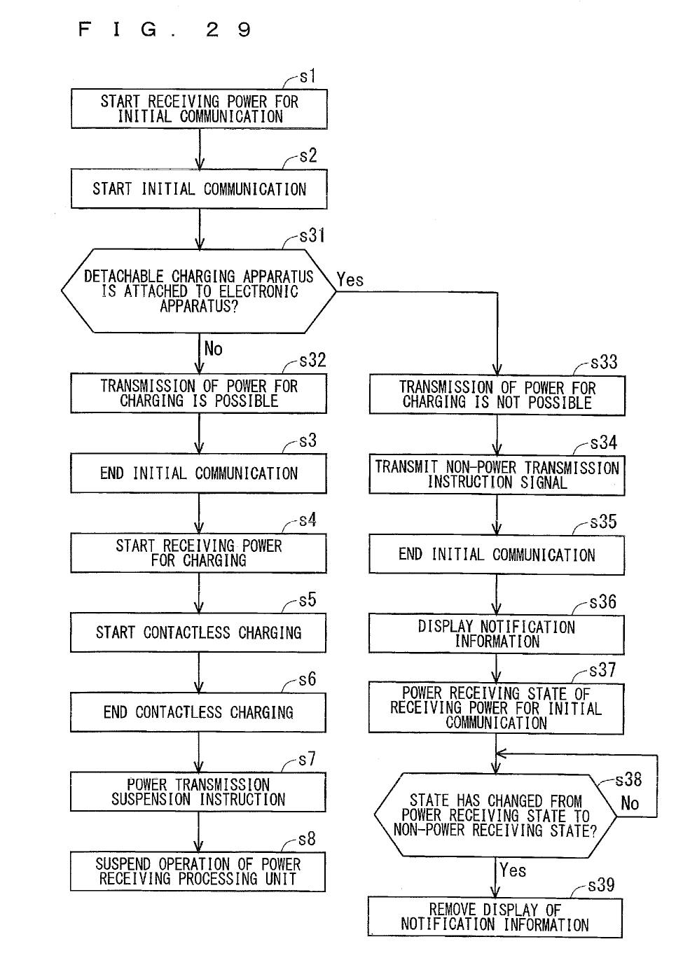

In a case where only the second notification icon 550 is displayed from among the second notification icon 550, the third notification information 600, and the fourth notification information 610 (see FIG. 23), the third notification information 600 and the fourth notification information 610 may be displayed when a predetermined operation is performed on the electronic apparatus 2. For example, when the user performs a tap operation on the second notification icon 550 with a finger 700 and the like as illustrated in FIG. 27, the third notification information 600 and the fourth notification information 610 may be displayed as illustrated in FIG. 22. Alternatively, when the user performs a downward slide operation from the notification screen 500 with the finger 700 and the like as illustrated in FIG. 28, the third notification information 600 and the fourth notification information 610 may be displayed as illustrated in FIG. 22. This allows the user to know more detailed information than information indicated by the second notification icon 550. Display of the third notification information 600 and the fourth notification information 610 may be removed after display for a period of time, or may be removed when a predetermined operation is performed on the display area 21.

Although the electronic apparatus 2 notifies, through display of information, the user that contactless charging is not performed in the above-mentioned examples, the electronic apparatus 2 may notify the user that contactless charging is not performed using another method. For example, the electronic apparatus 2 may notify the user that contactless charging is not performed through output of a predetermined sound from the external speaker 270. In a case where the electronic apparatus 2 can vibrate the apparatus case 20, the electronic apparatus 2 may notify the user that contactless charging is not performed through vibration of the apparatus case 20. In a case where the electronic apparatus 2 includes a light emitting unit including a light emitting diode and the like, and light emission of the light emitting unit is visible from the outside of the electronic apparatus 2, the electronic apparatus 2 may notify the user that contactless charging is not performed through light emission of the light emitting unit. The electronic apparatus 2 may notify the user that contactless charging is not performed using a plurality of methods. For example, the electronic apparatus 2 may notify the user that contactless charging is not performed through light emission of the light emitting unit while the display panel 230 displays predetermined information as illustrated in FIG. 22 and the like.

Similarly, the electronic apparatus 2 may notify the user that contactless charging is not performed unless the detachable charging apparatus 3 is detached from the electronic apparatus 2 using a method other than the method of displaying information, or may notify the user that contactless charging is not performed unless the detachable charging apparatus 3 is detached from the electronic apparatus 2 using a plurality of methods.

<Second Modification>

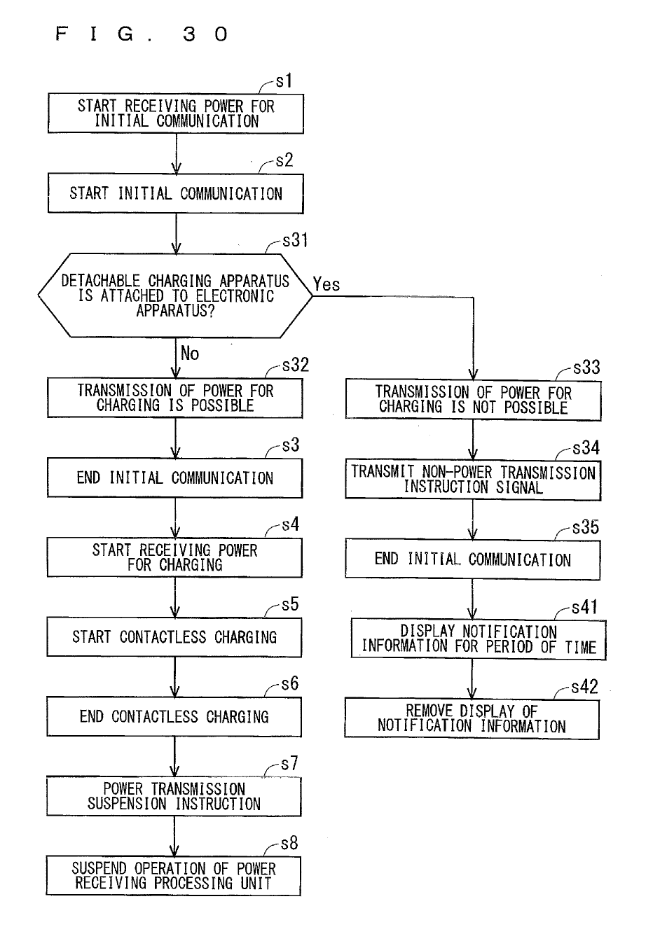

Although the electronic apparatus 2 judges whether the detachable charging apparatus 3 is attached to the electronic apparatus 2 regardless of whether the electronic apparatus 2 is mounted on the contactless charging apparatus 4 in the above-mentioned examples, the electronic apparatus 2 may judge whether the detachable charging apparatus 3 is attached to the electronic apparatus 2 when the electronic apparatus 2 is mounted on the contactless charging apparatus 4. FIG. 29 is a flowchart showing an example of the operation of the electronic apparatus 2 according to a second modification.

When the electronic apparatus 2 is mounted on the contactless charging apparatus 4, the power receiving processing unit 204 starts receiving, using the power receiving coil 205, the power for initial communication transmitted by the contactless charging apparatus 4 in step s1 as shown in FIG. 29, as in FIG. 17 described above. In step s2, the power receiving processing unit 204 starts the initial communication with the contactless charging apparatus 4 using the received power for initial communication as the power supply. When the initial communication starts, the power receiving processing unit 204 notifies the controller 210 accordingly.

When the initial communication starts, in step s31, the controller 210 judges whether the detachable charging apparatus 3 is attached to the electronic apparatus 2 as in step s11 described above. When the controller 210 judges that the detachable charging apparatus 3 is not attached to the electronic apparatus 2 in step s31, the controller 210 determines that transmission of the power for charging from the contactless charging apparatus 4 is possible in step s32. Thus, when the electronic apparatus 2 to which the detachable charging apparatus 3 has not been attached is mounted on the contactless charging apparatus 4, the power for charging is transmitted from the contactless charging apparatus 4. When the initial communication ends in step s3 after step s32, steps s4 and s5 described above are performed to start contactless charging of the battery 201. Contactless charging of the battery 201 then ends in step s6, and steps s7 and s8 are performed.

On the other hand, when the controller 210 judges that the detachable charging apparatus 3 is attached to the electronic apparatus 2 in step s11, the controller 210 determines that transmission of the power for charging from the contactless charging apparatus 4 is not possible in step s33. In step s34, the controller 210 controls the power receiving processing unit 204 so that the power receiving processing unit 204 transmits a non-power transmission instruction signal for instructing the contactless charging apparatus 4 not to transmit the power for charging. Steps s31 to s34 are performed during the initial communication.

When the contactless charging apparatus 4 receives the non-power transmission instruction signal from the power receiving processing unit 204 in the initial communication with the power receiving processing unit 204, the contactless charging apparatus 4 determines not to transmit the power for charging. When the initial communication with the power receiving processing unit 204 ends, the contactless charging apparatus 4 intermittently transmits the power for initial communication without transmitting the power for charging.

In the electronic apparatus 2, when the initial communication ends in step s35 after step s34, the controller 210 causes the display panel 230 to display the second notification icon 550, the third notification information 600, and the fourth notification information 610 in step s36. This causes the display in the display area 21 to be display as illustrated in FIG. 22 described above, for example. When the initial communication ends, the power receiving processing unit 204 notifies the controller 210 accordingly.

In step s37 after step s36, the power receiving processing unit 204 is in a power receiving state of intermittently receiving the power for initial communication intermittently transmitted from the contactless charging apparatus 4. The power receiving processing unit 204 herein does not perform the initial communication even when the power receiving processing unit 204 receives the power for initial communication. In step s38, the power receiving processing unit 204 judges whether the state of the power receiving processing unit 204 has changed from the power receiving state to a non-power receiving state of not receiving the power for initial communication at all. In step s38, the power receiving processing unit 204 judges that the state of the power receiving processing unit 204 has changed from the power receiving state to the non-power receiving state when no power is received from the contactless charging apparatus 4 for a predetermined period of time. The predetermined period of time is set to be greater than an interval (intermittent transmission interval) at which the contactless charging apparatus 4 transmits the power for initial communication. On the other hand, the power receiving processing unit 204 judges that the state of the power receiving processing unit 204 remains in the power receiving state when power is received from the contactless charging apparatus 4 during the predetermined period of time. When the power receiving processing unit 204 judges that the state of the power receiving processing unit 204 has changed from the power receiving state to the non-power receiving state, the power receiving processing unit 204 notifies the controller 210 that the state of the power receiving processing unit 204 has changed from the power receiving state to the non-power receiving state. The power receiving processing unit 204 repeatedly performs step s38 until the power receiving processing unit 204 judges that the state of the power receiving processing unit 204 has changed from the power receiving state to the non-power receiving state. It can be said that processing in step s38 is processing of judging whether the electronic apparatus 2 mounted on the contactless charging apparatus 4 has released from the contactless charging apparatus 4.

When it is judged that the state of the power receiving processing unit 204 has changed from the power receiving state to the non-power receiving state in step s38, the controller 210 causes the display panel 230 to remove display of the second notification icon 550, the third notification information 600, and the fourth notification information 610 in step s39. Display of the second notification icon 550, the third notification information 600, and the fourth notification information 610 is thus removed when, after the second notification icon 550, the third notification information 600, and the fourth notification information 610 are displayed, the electronic apparatus 2 is released from the contactless charging apparatus 4, and cannot receive power from the contactless charging apparatus 4.

After step s39, when the electronic apparatus 2 is mounted on the contactless charging apparatus 4 again, and the power receiving processing unit 204 receives the power for initial communication (step s1), step s2 is performed, and the electronic apparatus 2 thereafter operates in a similar manner.

As can be understood from the above-mentioned description, in the second modification, the second notification icon 550, the third notification information 600, and the fourth notification information 610 are displayed in the jacketed electronic apparatus 2 when the jacketed electronic apparatus 2 is mounted on the contactless charging apparatus 4. When the jacketed electronic apparatus 2 is then released from the contactless charging apparatus 4, display of the second notification icon 550, the third notification information 600, and the fourth notification information 610 is removed. When the jacketed electronic apparatus 2 is mounted on the contactless charging apparatus 4 again, the second notification icon 550, the third notification information 600, and the fourth notification information 610 are displayed again in the jacketed electronic apparatus 2.

As described above, in the second modification, the electronic apparatus 2 judges whether the detachable charging apparatus 3 is attached to the electronic apparatus 2 after the start of the initial communication with the contactless charging apparatus 4, in other words, when the electronic apparatus 2 is mounted on the contactless charging apparatus 4. The frequency of performing judgment processing of judging whether the detachable charging apparatus 3 is attached to the electronic apparatus 2 can thus be reduced.

In the second modification, the power receiving processing unit 204 transmits the non-power transmission instruction signal in the initial communication with the contactless charging apparatus 4. As the contactless charging apparatus 4 transmits the power for charging after completion of the initial communication, transmission of the non-power transmission instruction signal in the initial communication can more reliably suppress transmission of the power for charging from the contactless charging apparatus 4 to the jacketed electronic apparatus 2.

In the second modification, display of the second notification icon 550, the third notification information 600, and the fourth notification information 610 is removed when the state of the power receiving processing unit 204 has changed from the power receiving state to the non-power receiving state. This can suppress obtrusiveness, to the user, of display of the second notification icon 550, the third notification information 600, and the fourth notification information 610 for a long period of time.

As can be understood from the above-mentioned description, when step s1 is performed after performance of step s39, the state of the power receiving processing unit 204 has changed from the non-power receiving state to the power receiving state. When steps s2, s31, and s33 to s36 are performed, the second notification icon 550, the third notification information 600, and the fourth notification information 610 are displayed. That is to say, when, after the state of the power receiving processing unit 204 has changed from the power receiving state to the non-power receiving state, and display of the second notification icon 550, the third notification information 600, and the fourth notification information 610 is removed, the state of the power receiving processing unit 204 has changed from the non-power receiving state to the power receiving state, the second notification icon 550, the third notification information 600, and the fourth notification information 610 are displayed again. The user can thus check the second notification icon 550, the third notification information 600, and the fourth notification information 610 again.

As in the first modification, at least one of the second notification icon 550 and the third notification information 600 may be displayed in step s36 (see FIGS. 23 to 26).

In step s39, display of only the third notification information 600 and the fourth notification information 610 may be removed from among the second notification icon 550, the third notification information 600, and the fourth notification information 610. After step s39, display of the second notification icon 550 is removed, for example, when the detachable charging apparatus 3 is detached from the electronic apparatus 2. Display of the second notification icon 550 may be removed a period of time after removal of display of the third notification information 600 and the fourth notification information 610 in step s39. Display of the second notification icon 550 may be removed immediately after steps s1, s2, s31, and s32 are performed after the detachable charging apparatus 3 is detached from the electronic apparatus 2 after step s39, and the electronic apparatus 2 is then mounted on the contactless charging apparatus 4.

Only the third notification information 600 and the fourth notification information 610 may be displayed from among the second notification icon 550, the third notification information 600, and the fourth notification information 610 in step s36, and display of the third notification information 600 and the fourth notification information 610 may be removed, and the second notification icon 550 may be displayed in step s39. After step s39, display of the second notification icon 550 is removed, for example, when the detachable charging apparatus 3 is detached from the electronic apparatus 2. Display of the second notification icon 550 may be removed a period of time after removal of display of the third notification information 600 and the fourth notification information 610 in step s39. Display of the second notification icon 550 may be removed immediately after steps s1, s2, s31, and s32 are performed after the detachable charging apparatus 3 is detached from the electronic apparatus 2 after step s39, and the electronic apparatus 2 is then mounted on the contactless charging apparatus 4. When the second notification icon 550 is displayed in step s39, the controller 210 may suspend the operation of the power receiving processing unit 204 in step s39. This reduces power consumption of the electronic apparatus 2. In this case, the controller 210 operates the suspended power receiving processing unit 204 when the detachable charging apparatus 3 is detached from the electronic apparatus 2.

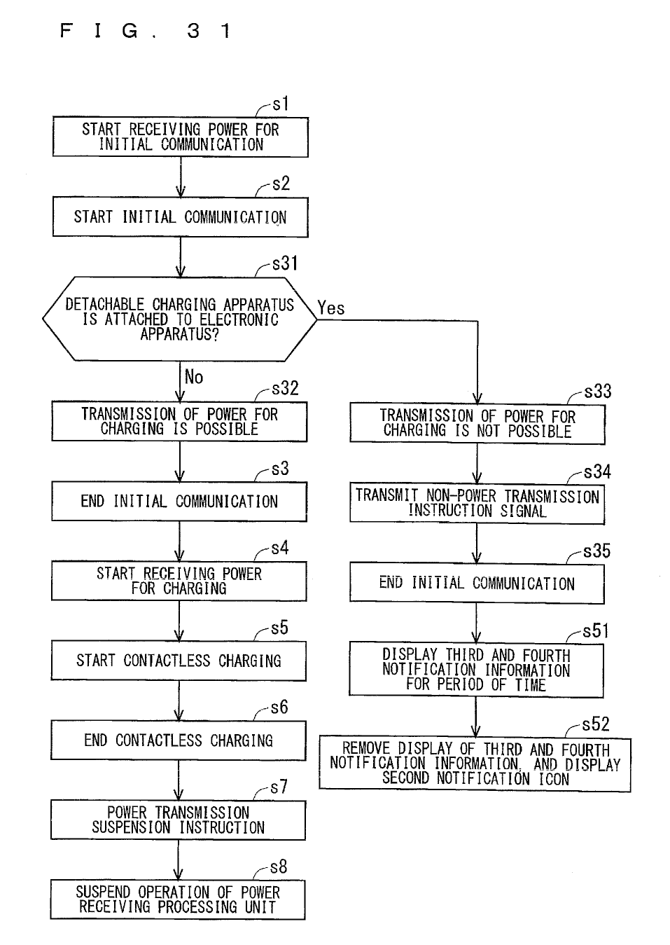

As shown in FIG. 30, steps s41 and s42 may be performed in place of steps s36 to s39. In step s41, the second notification icon 550, the third notification information 600, and the fourth notification information 610 are displayed for a period of time, and then, in step s42, display of the second notification icon 550, the third notification information 600, and the fourth notification information 610 is removed. That is to say, in the example of FIG. 30, after the second notification icon 550, the third notification information 600, and the fourth notification information 610 are displayed for the period of time, display of the second notification icon 550, the third notification information 600, and the fourth notification information 610 is removed.

As shown in FIG. 31, steps s51 and s52 may be performed in place of steps s36 to s39. In step s51, only the third notification information 600 and the fourth notification information 610 are displayed for a period of time from among the second notification icon 550, the third notification information 600, and the fourth notification information 610, and then, in step s52, display of the third notification information 600 and the fourth notification information 610 is removed, and the second notification icon 550 is displayed. That is to say, in the example of FIG. 31, after the third notification information 600 and the fourth notification information 610 are displayed for the period of time without displaying the second notification icon 550, display of the third notification information 600 and the fourth notification information 610 is removed, and the second notification icon 550 is displayed. After step s52, display of the second notification icon 550 is removed, for example, when the detachable charging apparatus 3 is detached from the electronic apparatus 2. Display of the second notification icon 550 in step s52 may be removed a period of time after display of the second notification icon 550 in step s52. Display of the second notification icon 550 in step s52 may be removed immediately after steps s1, s2, s31, and s32 are performed after the detachable charging apparatus 3 is detached from the electronic apparatus 2 after step s52, and the electronic apparatus 2 is then mounted on the contactless charging apparatus 4. In step s52, the controller 210 may suspend the operation of the power receiving processing unit 204. This reduces power consumption of the electronic apparatus 2. In this case, the controller 210 operates the suspended power receiving processing unit 204 when the detachable charging apparatus 3 is detached from the electronic apparatus 2.

As in the first modification, in a case where only the second notification icon 550 is displayed from among the second notification icon 550, the third notification information 600, and the fourth notification information 610 (see FIG. 23), the third notification information 600 and the fourth notification information 610 may be displayed when a predetermined operation is performed on the electronic apparatus 2 as illustrated in FIGS. 27 and 28.

As in the first modification, the electronic apparatus 2 may notify the user that contactless charging is not performed using a method other than the method of displaying information, or may notify the user that contactless charging is not performed using a plurality of methods. The electronic apparatus 2 may notify the user that contactless charging is not performed unless the detachable charging apparatus 3 is detached from the electronic apparatus 2 using a method other than the method of displaying information, or may notify the user that contactless charging is not performed unless the detachable charging apparatus 3 is detached from the electronic apparatus 2 using a plurality of methods.

While the electronic apparatus system 1 has been described in detail above, the foregoing description is in all aspects illustrative and does not restrict the present disclosure. Various modifications described above are applicable in combination unless any contradiction occurs. It is understood that numerous modifications not having been exemplified can be devised without departing from the scope of the disclosure.

### EXPLANATION OF REFERENCE SIGNS

1 electronic apparatus system
2 electronic apparatus
3 detachable charging apparatus
4 contactless charging apparatus
21 display area
201, 301 battery
202 charging processing unit
203 charging controller
204 power receiving processing unit
210 controller
230 display panel

1. An electronic apparatus comprising
a first battery to be charged by a detachable charging apparatus and a contactless charging apparatus, wherein
the detachable charging apparatus includes a second battery, and is detachably attachable to a surface of the electronic apparatus, and
the electronic apparatus further comprises:
a charging processing unit configured to perform first charging and second charging, the first charging being charging of the first battery using first power of the second battery supplied from the detachable charging apparatus attached to the electronic apparatus, the second charging being charging of the first battery using second power transmitted from the contactless charging apparatus in a contactless manner; and
at least one processor configured to judge whether the detachable charging apparatus is attached to the electronic apparatus, and
configured to determine, when the at least one processor judges that the detachable charging apparatus is attached to the electronic apparatus, that transmission of the second power from the contactless charging apparatus is not possible.

2. The electronic apparatus according to claim 1, wherein
when the at least one processor determines that transmission of the second power is not possible, the electronic apparatus instructs the contactless charging apparatus not to transmit the second power.

3. The electronic apparatus according to claim 1, wherein
the charging processing unit includes:
a power receiving processing unit configured to receive the second power, and generate an output voltage based on the received second power and output the output voltage; and
a charging controller configured to charge the first battery based on the output voltage, and charge the first battery using the first power,
the power receiving processing unit performs initial communication with the contactless charging apparatus using third power transmitted from the contactless charging apparatus in a contactless manner,
the contactless charging apparatus starts transmission of the second power after the initial communication, and
when the at least one processor determines that transmission of the second power is not possible, the electronic apparatus suspends operation of the power receiving processing unit.

4. The electronic apparatus according to claim 1, further comprising
a notification unit configured to notify, when transmission of the second power is not possible, a user that the second charging is not performed.

5. The electronic apparatus according to claim 4, wherein
the notification unit includes a display, and
when transmission of the second power is not possible, the display displays notification information notifying the user that the second charging is not performed.

6. The electronic apparatus according to claim 4, wherein
when transmission of the second power is not possible, the notification unit notifies a user that the second charging is not performed unless the detachable charging apparatus is detached from the electronic apparatus.

7. The electronic apparatus according to claim 6, wherein
the notification unit includes a display, and
when transmission of the second power is not possible, the display displays notification information notifying the user that the second charging is not performed unless the detachable charging apparatus is detached from the electronic apparatus.

8. The electronic apparatus according to claim 2, wherein
the electronic apparatus performs initial communication with the contactless charging apparatus using third power transmitted from the contactless charging apparatus in a contactless manner,
the contactless charging apparatus starts transmission of the second power after the initial communication, and
the at least one processor judges whether the detachable charging apparatus is attached to the electronic apparatus after the electronic apparatus starts the initial communication.

9. The electronic apparatus according to claim 8, wherein
when the at least one processor determines that transmission of the second power is not possible, the electronic apparatus instructs the contactless charging apparatus not to transmit the second power in the initial communication.

10. The electronic apparatus according to claim 1, further comprising
a notification unit configured to notify, when transmission of the second power is not possible, a user that the second charging is not performed, wherein
the electronic apparatus performs initial communication with the contactless charging apparatus using third power transmitted from the contactless charging apparatus in a contactless manner,
the contactless charging apparatus starts transmission of the second power after the initial communication,
the contactless charging apparatus intermittently transmits the third power when the contactless charging apparatus does not transmit the second power, and
in a case where transmission of the second power is not possible, the notification unit
notifies the user that the second charging is not performed when a state of the electronic apparatus is a first state of intermittently receiving the third power, and
suspends notification to the user that the second charging is not performed when the state of the electronic apparatus has changed from the first state to a second state of not receiving the third power.

11. The electronic apparatus according to claim 1, wherein
the charging processing unit includes:
a power receiving processing unit configured to receive the second power, and generate an output voltage based on the received second power and output the output voltage; and
a charging controller configured to charge the first battery based on the output voltage, and charge the first battery based on the first power, and
when the at least one processor determines that transmission of the second power is not possible, the electronic apparatus suspends operation of the power receiving processing unit.

12. The electronic apparatus according to claim 1, further comprising
a display, wherein
when transmission of the second power is not possible, the display displays, from among a notification icon notifying a user that the second charging is not performed and notification information notifying the user that the second charging is not performed unless the detachable charging apparatus is detached from the electronic apparatus, at least the notification information for a period of time, and then removes display of the notification information.

13. The electronic apparatus according to claim 12, wherein
after the display displays, from among the notification icon and the notification information, at least the notification information for the period of time, the display removes display of the notification information, and displays the notification icon.

14. The electronic apparatus according to claim 1, further comprising
a display, wherein
the electronic apparatus performs initial communication with the contactless charging apparatus using third power transmitted from the contactless charging apparatus in a contactless manner,
the contactless charging apparatus starts transmission of the second power after the initial communication,
the contactless charging apparatus intermittently transmits the third power when the contactless charging apparatus does not transmit the second power, and
in a case where transmission of the second power is not possible, the display
displays, from among a notification icon notifying a user that the second charging is not performed and notification information notifying the user that the second charging is not performed unless the detachable charging apparatus is detached from the electronic apparatus, at least the notification information when a state of the electronic apparatus is a first state of intermittently receiving the third power, and
removes display of the notification information when the state of the electronic apparatus has changed from the first state to a second state of not receiving the third power.

15. The electronic apparatus according to claim 14, wherein
in a case where transmission of the second power is not possible, the display displays the notification information again when the state of the electronic apparatus has changed from the second state to the first state after removal of display of the notification information.

16. The electronic apparatus according to claim 14, wherein
in a case where transmission of the second power is not possible, the display removes display of the notification information, and displays the notification icon when the state of the electronic apparatus has changed from the first state to the second state.

17. The electronic apparatus according to claim 13, wherein
in a case where the display displays only the notification icon from among the notification icon and the notification information, the display displays the notification information when a predetermined operation is performed on the electronic apparatus.

18. The electronic apparatus according to claim 16, wherein
the charging processing unit includes:
a power receiving processing unit configured to receive the second power, and generate an output voltage based on the received second power and output the output voltage; and
a charging controller configured to charge the first battery based on the output voltage, and charge the first battery based on the first power,
the power receiving processing unit receives the third power, and performs the initial communication with the contactless charging apparatus using the received third power, and
in a case where transmission of the second power is not possible,
the display displays at least the notification information from among the notification icon and the notification information when a state of the power receiving processing unit is the first state, and
when the state of the power receiving processing unit has changed from the first state to the second state, the display removes display of the notification information, and displays the notification icon, and the electronic apparatus suspends operation of the power receiving processing unit.

19. An electronic apparatus system, comprising:
an electronic apparatus including a first battery to be charged by a contactless charging apparatus; and
a detachable charging apparatus including a second battery, being detachably attachable to a surface of the electronic apparatus, and charging the first battery, wherein
the electronic apparatus includes:
a charging processing unit configured to perform first charging and second charging, the first charging being charging of the first battery using first power of the second battery supplied from the detachable charging apparatus attached to the electronic apparatus, the second charging being charging of the first battery using second power transmitted from the contactless charging apparatus in a contactless manner; and
at least one processor configured to judge whether the detachable charging apparatus is attached to the electronic apparatus; and
configured to determine, when the at least one processor judges that the detachable charging apparatus is attached to the electronic apparatus, that transmission of the second power from the contactless charging apparatus is not possible.

20. An electronic apparatus system, comprising:
an electronic apparatus including a first battery to be charged by a detachable charging apparatus; and
a contactless charging apparatus charging the first battery, wherein
the detachable charging apparatus includes a second battery, and is detachably attachable to a surface of the electronic apparatus, and
the electronic apparatus includes:
a charging processing unit configured to perform first charging and second charging, the first charging being charging of the first battery using first power of the second battery supplied from the detachable charging apparatus attached to the electronic apparatus, the second charging being charging of the first battery using second power transmitted from the contactless charging apparatus in a contactless manner; and
at least one processor configured to judge whether the detachable charging apparatus is attached to the electronic apparatus, and
configured to determine, when the at least one processor judges that the detachable charging apparatus is attached to the electronic apparatus, that transmission of the second power from the contactless charging apparatus is not possible.

21. An electronic apparatus system, comprising:
an electronic apparatus including a first battery;
a detachable charging apparatus including a second battery, being detachably attachable to a surface of the electronic apparatus, and charging the first battery; and
a contactless charging apparatus charging the second battery, wherein
the electronic apparatus includes:
a charging processing unit configured to perform first charging and second charging, the first charging being charging of the first battery using first power of the second battery supplied from the detachable charging apparatus attached to the electronic apparatus, the second charging being charging of the first battery using second power transmitted from the contactless charging apparatus in a contactless manner; and
at least one processor configured to judge whether the detachable charging apparatus is attached to the electronic apparatus, and
configured to determine, when the at least one processor judges that the detachable charging apparatus is attached to the electronic apparatus, that transmission of the second power from the contactless charging apparatus is not possible.

22. A method of operating an electronic apparatus including a first battery to be charged by a detachable charging apparatus and a contactless charging apparatus, the detachable charging apparatus including a second battery, and being detachably attachable to a surface of the electronic apparatus, the method comprising:
performing first charging and second charging, the first charging being charging of the first battery using first power of the second battery supplied from the detachable charging apparatus attached to the electronic apparatus, the second charging being charging of the first battery using second power transmitted from the contactless charging apparatus in a contactless manner;
judging whether the detachable charging apparatus is attached to the electronic apparatus; and
determining, when it is judged that the detachable charging apparatus is attached to the electronic apparatus, that transmission of the second power from the contactless charging apparatus is not possible.

23. The electronic apparatus according to claim 14, wherein
in a case where the display displays only the notification icon from among the notification icon and the notification information, the display displays the notification information when a predetermined operation is performed on the electronic apparatus.
